(19) United States
(12) Patent Application Publication
(10) Pub. No.: US 2026/0076371 A1
(43) Pub. Date: Mar. 19, 2026

(54) AGROCHEMICAL COMPOSITION OF TRIAZOLES

(71) Applicant: Adama Makhteshim Ltd., Beer Sheva (IL)

(72) Inventors: Jenny Lerner Yardeni, Mishmar Hanegev (IL); Alexander Tolts, Beer Sheva (IL); Michael Berkovitch, Ashdod (IL); Gilad Silbert, Kibutz Dorot (IL)

(73) Assignee: Adama Makhteshim Ltd., Beer Sheva (IL)

(21) Appl. No.: 19/394,076

(22) Filed: Nov. 19, 2025

Related U.S. Application Data
(62) Division of application No. 17/796,149.
(60) Provisional application No. 62/966,587, filed on Jan. 28, 2020.

(51) Int. Cl. A01N 43/653; A01P 3/00

(52) U.S. Cl. CPC A01N 43/653; A01P 3/00

(57) ABSTRACT

The invention relates to novel agrochemical compositions comprising: a) at least one triazole fungicide; b) carbonyl containing solvent; and c) N-alkyl pyrrolidone of formula (I) wherein R1 is a straight or branched, saturated or unsaturated, substituted or unsubstituted hydrocarbon group having from 5 to 10 carbon atoms. The invention also relates to the use of a combination of the abovementioned N-alkyl pyrrolidone of formula (I) with a carbonyl containing solvent for increasing the efficacy of one or more triazole fungicide. The invention further relates to an agrochemical composition comprising: a) at least one triazole fungicide; b) a carbonyl containing solvent; c) N-alkyl pyrrolidone of formula (I) and d) an effective amount of compound of formula (II) wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atom, m is an integer equal to 2, n is an integer equal to 3, x is an integer of from 3 to 50 and y is an integer of from 0 to 50. The invention relates to the use of a compound of formula (II) for increasing the efficacy of one or more triazole fungicide; and to a method of treating plants or plant parts with a combination of one or more triazole(s) fungicide with compound of formula wherein the compound of formula (II) is for increasing the efficacy of the one or more triazole(s).

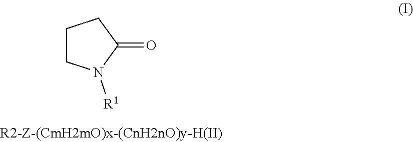

This application is a divisional of U.S. application Ser. No. 17/796,149, filed Jul. 28, 2022, which is a § 371 national stage of PCT International Application No. PCT/IB2021/050683, filed Jan. 28, 2021, which claims the benefit of U.S. Provisional Application No. 62/966,587, filed Jan. 28, 2020, the entire contents of each of which are hereby incorporated by reference into the subject application.

Throughout this application various publications are referenced. The disclosures of these documents in their entireties are hereby incorporated by reference into this application in order to more fully describe the state of the art to which this invention pertains.

### TECHNICAL FIELD OF THE INVENTION

The present invention relates to novel compositions of triazole fungicides for controlling plant diseases and a method for controlling plant diseases which possesses excellent control efficacy.

### BACKGROUND OF THE INVENTION

Triazoles are an important class of active ingredients in the pesticide field as they inhibit C14-demethylase enzymes which play an essential role in sterol production. Sterols, such as ergosterol, are needed for fungal membrane structure and function, making them critical for the development of functional cell walls. Triazoles cause an abnormal fungal growth that results in death and therefore, are widely used for the treatment of fungal infections.

Triazole fungicides are economically important agricultural chemicals as they are widely used on crops such as wheat, barley, soybean and orchard fruits and have protective, curative and eradicant properties.

One such fungicidal triazole is 2-[2-(1-chlorocyclopropyl)-3-(2-chloro-phenyl)-2-hydroxy-propyl]-2,4-dihydro-3H-1,2,4-triazole-3-thione, also known as prothioconazole (WO 1996/16048).

Fusarium head blight is a very important disease of small grain cereals with F culmorum and F. graminearum as some of the most important causal agents. These species can attack wheat and other cereals over a broad range of environments and temperatures. These pathogens not only cause reduction in yield and quality but also reduces the quality of the grain by contamination with mycotoxins such as deoxynivalenol (DON) which can accumulate to toxic levels for humans and animals.

The efficacy of agrochemicals as crop protection agents is generally a function of the intrinsic properties of the active ingredients, such as their toxicity, plant movement, penetration capacity, and mechanism of action. However, it is also influenced by the formulation and the mode of application of the commercial product which includes solvents and/or solvent mixtures, surfactants and adjuvants among other parameters. Different formulations of the same active ingredient may have different efficacies. This is a result of formulation aids which can alter biological activity of the pesticide by, for example, changing the stability, solubility, crystallization, photochemical degradation, duration of delivery of the active ingredient etc.

Based on all the above there is a need to provide stable and safe novel compositions of triazole fungicides for controlling plant diseases and a method for controlling plant diseases which possesses excellent control efficacy.

The invention provides novel, improved triazole containing compositions which have high storage stability and exhibit high efficacy as fungicidal agents.

It has surprisingly been found that the compositions of the present invention exhibit high efficacy in reducing mycotoxins levels such as deoxynivalenol (DON).

### SUMMARY OF THE INVENTION

The present invention therefore provides an agrochemical composition comprising:
a) at least one triazole fungicide;
b) a carbonyl containing solvent; and
c) N-alkyl pyrrolidone of formula (I):

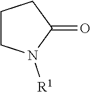

wherein R1 is a straight or branched, saturated or unsaturated, substituted or unsubstituted hydrocarbon group having from 5 to 10 carbon atoms.

In other embodiments, the present invention is directed to the use of a combination of a carbonyl containing solvent with N-alkyl pyrrolidone of formula (I), wherein R1 is a straight or branched, saturated or unsaturated, substituted or unsubstituted hydrocarbon group having from 5 to 10 carbon atoms for increasing the efficacy of one or more triazole fungicide.

In yet other embodiments the present invention is directed to an agrochemical composition comprising:
a) at least one triazole fungicide;
b) a carbonyl containing solvent;
c) N-alkyl pyrrolidone of formula (I):

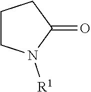

wherein R1 is a straight or branched, saturated or unsaturated, substituted or unsubstituted hydrocarbon group having from 5 to 10 carbon atoms; and
d) an effective amount of compound of formula (II):

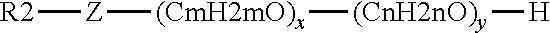

wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atom, m is an integer equal to 2, n is an integer equal to 3, x is an integer of from 3 to 50 and y is an integer of from 0 to 50.

In other embodiments the present invention also provides the use of a compound of formula (II):

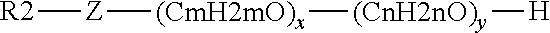

wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atom, m is an integer equal to 2, n is an integer equal to 3, x is an integer of from 3 to 50 and y is an integer of from 0 to 50, for increasing the efficacy of one or more triazole fungicide.

In some embodiments the present invention provides a method of treating plants or plant parts with a combination of one or more triazole fungicide with compound of formula (II):

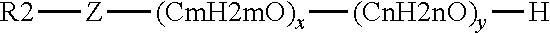

wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atom, m is an integer equal to 2, n is an integer equal to 3, n is an integer of from 2 to 3, x is an integer of from 3 to 50 and y is an integer of from 0 to 50.
wherein the compound of formula (II) is for increasing the efficacy of the one or more triazole(s).

### BRIEF DESCRIPTION OF THE FIGURES

FIG. 1 shows leaves not inoculated vs. inoculated, UTC.

FIG. 2 shows leaf migration of formulation J Vs. Proline 275 EC.

FIG. 3 shows the acropetal and basipetal migration of prothioconazole.

### DETAILED DESCRIPTION OF THE PREFERRED EMBODIMENTS

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and in the claims and its conjugations are used in its non-limiting sense to mean that items following the word are included, but items not specifically mentioned are not excluded.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “pest” includes, but is not limited to, unwanted phytopathogenic harmful fungi, unwanted insect, unwanted nematode, and weed.

As used herein, the term “pesticide” broadly refers to an agent that can be used to prevent, control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, U K, 2003-04), the contents of each of which are incorporated herein by reference in their entirety.

As used herein, the term “locus” includes not only areas where the pest may already be developed, but also areas where pests have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. spores, corms, bulbs, rhizomes, sprouts basal shoots, stolons, and buds and other parts of plants, including seedlings and young plants, which are to be transplanted after germination or after emergence from soil.

As used herein the term “ha” refers to hectare.

The present invention provides an agrochemical composition comprising:
a) at least one triazole fungicide;
b) a carbonyl containing solvent; and
c) N-alkyl pyrrolidone of formula (I):

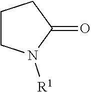

wherein R1 is a straight or branched, saturated or unsaturated, substituted or unsubstituted hydrocarbon group having from 4 to 10 carbon atoms;

In some embodiments, the at least one triazole fungicide is selected from azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof. In some embodiments, the triazole fungicide is prothioconazole, tebuconazole and any mixture thereof. In some embodiments, the triazole fungicide is tebuconazole. In some embodiments, the triazole fungicide is prothioconazole.

In some embodiments, the compositions of the present invention comprise a carbonyl containing solvent which is selected from the groups of ketones, amides, ureas, esters, lactones, carbonates and any mixtures thereof.

In some embodiments, the ketone solvent is selected from acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctenone (30), 2,4,6-cycloheptatrien-1-one, acetophenone, propiophenone (19), 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone, valerophenone and any mixtures thereof. In a preferred embodiment the ketone is cyclohexanone, acetophenone, heptanone and any mixtures thereof. In a more preferred embodiment, the ketone is acetophenone.

In some embodiments, the amide solvent is selected from N-formylmorpholine, N,N-dimethylformamide, N,N-dimethylacetamide, N,N-imethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, 1,3-dimethyl-2-imidazolidinone, 1,3,4-trimethyl-2-imidazolidinone, 1,3-dimethyl-3,4,5,6-tetrahydro-2(1H)pyrimidinone, 1-heptyl-3-methyl-2-imidazolidinone, 1-heptyl-1,3-dihydro-3-methyl-2H-imidazol2-one and any mixture thereof. In a preferred embodiment the amide is N,N-dimethyldecanamide, N,N-dimethyldecenamide, N,N-dimethyl-octanamide and any mixtures thereof.

In some embodiments, the urea solvent is selected from tetramethylurea, tetraethylurea and any mixture thereof.

In some embodiments, the lactone solvent is selected from butyrolactone, alpha-methyl-gamma-butyrolactone, gamma-valerolactone, delta-valerolactone and any mixture thereof.

In some embodiments, the carbonate solvent is selected from dimethyl carbonate, methyl ethyl carbonate, diethyl carbonate, dipropyl carbonate, diisopropyl carbonate, dibutyl carbonate, dipentyl carbonate, dihexyl carbonate, diheptyl carbonate, dioctyl carbonate, dinonyl carbonate, didecyl carbonate, ethylene carbonate, 4-methyl-1,3-dioxolan-2-one, 4-(methoxymethyl)-1,3-dioxolan-2-one, glycerol carbonate, butylene carbonate, 4,6-dimethyl-3-dioxan-2-one, dibenzyl carbonate and any mixture thereof.

In some embodiments, the compositions of the present invention comprise, N-alkyl pyrrolidone of formula (I), wherein R1 is a hydrocarbon group having from 7 to 9 carbon atoms. In a preferred embodiment R1 is a hydrocarbon group having 8 carbon atoms.

In a preferred embodiment, the carbonyl containing solvent is acetophenone and the N-alkyl pyrrolidone is N-octyl pyrrolidone.

In a preferred embodiment, the carbonyl containing solvent is acetophenone and the N-alkyl pyrrolidone is N-octyl pyrrolidone wherein the ratio between the acetophenone and the N-octyl pyrrolidone is of about 2:1.

In a preferred embodiment, the triazole is prothioconazole, the carbonyl containing solvent is acetophenone and the N-alkyl pyrrolidone is N-octyl pyrrolidone.

In some embodiments, the ratio between the carbonyl containing solvent and the N-alkyl pyrrolidone of formula (I) is of about 0.5:1 to about 3:1. In a more preferred embodiment, the ratio between the carbonyl containing solvent and the N-alkyl pyrrolidone of formula (I) is of about 1:1 to about 2:1.

In a preferred embodiment, the triazole is prothioconazole, the carbonyl containing solvent is acetophenone and the N-alkyl pyrrolidone is N-octyl pyrrolidone wherein the ratio between acetophenone and N-octyl pyrrolidone is of about 2:1.

In some embodiments, the amount of triazole fungicide in the compositions of the present invention is about 0.1% to about 50% by weight, based on the total weight of the composition. In a preferred embodiment, the amount of triazole fungicide in the composition is about 10% to about 30% by weight, based on the total weight of the composition. In a more preferred embodiment, the amount of triazole fungicide in the composition is about 20% to about 25% by weight, based on the total weight of the composition. In a specially preferred embodiment, the amount of triazole fungicide in the composition is of about 25% weight, based on the total weight of the composition.

In a preferred embodiment, the triazole is prothioconazole, the carbonyl containing solvent is acetophenone and the N-alkyl pyrrolidone is N-octyl pyrrolidone. In a specific embodiment, the ratio between acetophenone and the N-octyl pyrrolidone is of about 2:1. In another specific embodiment, prothioconazole is in an amount of about 25% weight, based on the total weight of the composition.

The present invention also provides a method for controlling and/or preventing pests comprising applying an effective amount of the composition to a locus where the pest is to be controlled and/or prevented so as to thereby control and/or prevent the pest.

In some embodiments, the pest to be controlled and/or prevented is selected for example from phytopathogenic harmful fungi, insects, arachnids, nematodes and weeds. In a preferred embodiment, the pest to be controlled and/or prevented is a phytopathogenic harmful fungi.

The present invention also provides a method for controlling and/or preventing phytopathogenic harmful fungi comprising applying an effective amount of the compositions of the present invention to a locus where the phytopathogenic harmful fungi is to be controlled so as to thereby control the phytopathogenic harmful fungi.

In some embodiments, the locus where the phytopathogenic harmful fungi to be controlled is a crop field.

The present invention also provides a method of controlling phytopathogenic harmful fungi in a field of crop comprising applying an effective amount of the compositions disclosed herein to a field of crop so as to thereby control the phytopathogenic harmful fungi in the field of crop.

In some embodiments, the crop is selected from the group consisting of cotton, flax, grapevines, fruit, vegetables, such as Rosaceae sp. (for example pome fruit such as apples and pears, but also stone fruit such as apricots, cherries, almonds and peaches, and berry fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, organs and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumbers), Alliaceae sp. (for example leeks, onions), Papilionaceae sp. (for example peas); main crop plants such as Gramineae sp. (for example maize, turfgrass, cereals such as wheat, rye, rice, barley, oats, sorghum/millet and triticale), Asteraceae sp. (for example sunflowers), Brassicaceae sp. (for example white cabbage, red cabbage, broccoli, cauliflower, Brussels sprouts, Pak Choi, kohlrabi, radishes, and rapeseed, mustard, horseradish and cress), Fabacae sp. (for example beans, peanuts), Papilionaceae sp. (for example soya beans), Solanaceae sp. (for example potatoes), Chenopodiaceae sp. (for example sugar beet, fodder beet, chard, beetroot); sugarcane, poppies, olives, coconuts, cocoa, tobacco and useful plants and ornamental plants in gardens and forests; and genetically modified varieties of each of these plants, and the seeds of these plants. In a preferred embodiment, the crop is selected from the group consisting of wheat, rye, rice, barley, oats, sorghum/millet, triticale, maize, rapeseed, beans, peanuts and sunflowers. In a more preferred embodiment, the crop is selected from the group consisting of wheat, rye, rice, barley, oats, sorghum/millet and triticale.

Non-limiting examples of pathogens of fungal diseases which may be treated in accordance with the invention include: diseases caused by powdery mildew pathogens, for example Blumeria species, for example Blumeria graminis, Podosphaera species, for example Podosphaera leucotricha, Sphaerotheca species, for example Sphaerotheca fuliginea, Uncinula species, for example Uncinula necator, for example Erysiphe species; diseases caused by rust disease pathogens, for example Gymnosporangium species, for example Gymnosporangium sabinae; Hemileia species, for example Hemileia vastatrix; Phakopsora species, for example Phakopsora pachyrhizi or Phakopsora meibomiae Puccinia species, for example Puccinia recondita, Puccinia graminis oder Puccinia striif ormis, Uromyces species, for example Uromyces appendiculatus, diseases caused by pathogens from the group of the Oomycetes, for example Albugo species, for example Albugo Candida, Bremia species, for example Bremia laciucaer, Peronospora species, for example Peronospora pisi or P. brassicaer, Phytophthora species, for example Phytophthora infestans, Plasmopara species, for example Plasmopara viticola, Pseudoperonospora species, for example Pseudoperonospora humuli or Pseudoperonospora cubensis, Pythium species, for example Pythium ultimunv, leaf blotch diseases and leaf wilt diseases caused, for example, by Alternaria species, for example Alternaria solanv, Cercospora species, for example Cercospora beticola, Cladiosporium species, for example Cladiosporium cucumerinunr, Cochliobolus species, for example Cochliobolus sativus (conidial form: Drechslera, syn: Helminthosporium) or Cochliobolus miyabeanus, Colletotrichum species, for example Colletotrichum lindemuthaniunv, Corynespora species, for example Corynespora cassiicola, Cycloconium species, for example Cycloconium oleaginunv, Diaporthe species, for example Diaporthe citrv, Elsinoe species, for example Elsinoe fawcettii, Gloeosporium species, for example Gloeosporium laeticolor, Glomerella species, for example Glomerella cingulata, Guignardia species, for example Guignardia bidwellv, Leptosphaeria species, for example Leptosphaeria maculans, Magnaporthe species, for example Magnaporthe grisea, Microdochium species, for example Microdochium nivaler, Mycosphaerella species, for example Mycosphaerella graminicola (also known as Septoria tritici), Mycosphaerella arachidicola or Mycosphaerella fi j iens, Phaeosphaeria species, for example Phaeosphaeria nodorunr, Pyrenophora species, for example Pyrenophora teres or Pyrenophora tritici rep enth, Ramularia species, for example Ramularia collo-cygni or Ramularia areola, Rhynchosporium species, for example Rhynchosporium secalis, Septoria species, for example Septoria apii or Septoria lycopersicv, Stagonospora species, for example Stagonospora nodorunr, Typhula species, for example Typhula incarnata, Venturia species, for example Venturia inaequal, root and stem diseases caused, for example, by Corticium species, for example Corticium graminearum, Fusarium species, for example Fusarium oxysporum\Gaeumannomyces species, for example Gaeumannomyces graminis, Plasmodiophora species, for example Plasmodiophora brassica, Rhizoctonia species, for example Rhizoctonia solani, Sarocladium species, for example Sarocladium oryzae; Sclerotium species, for example Sclerotium oryzae, Tapesia species, for example Tapesia acuf ormis, Thielaviopsis species, for example Thielaviopsis basicola, ear and panicle diseases (including com cobs) caused, for example, by Alternaria species, for example Alternaria spp.; Aspergillus species, for example Aspergillus flavus, Cladosporium species, for example Cladosporium cladosporioides, Claviceps species, for example Claviceps purpurea, Fusarium species, for example Fusarium culmorunr, Gibberella species, for example Gibberella zeae Monographella species, for example Monographella nivalis, Stagnospora species, for example Stagnospora nodorunr, diseases caused by smut fungi, for example Sphacelotheca species, for example Sphacelotheca reiliana, Tilletia species, for example Tilletia caries or Tilletia controversy, Urocystis species, for example Urocystis occulta, Ustilago species, for example Ustilago nuda, fruit rot caused, for example, by Aspergillus species, for example Aspergillus flavus, Botrytis species, for example Botrytis cinerea, Monilinia species, for example Monilinia Iαχα, Penicillium species, for example Penicillium expansum or Penicillium purpurogenum, Rhizopus species, for example Rhizopus stolonifer, Sclerotinia species, for example Sclerotinia sclerotiorum, Verticilium species, for example Verticilium alboatrum, seed- and soil-borne rot and wilt diseases, and also diseases of seedlings, caused, for example, by Alternaria species, for example Alternaria brasside ola Aphanomyces species, for example Aphanomyces euteiches, Ascochyta species, for example Ascochyta lends, Aspergillus species, or example Aspergillus flavus, Cladosporium species, for example Cladosporium herbarum, Cochliobolus species, for example Cochliobolus sativus (conidial form: Drechslera, Bipolaris Syn: Helminthosporium), Colletotrichum species, for example Colletotrichum coccodes, Fusarium species, for example Fusarium culmorum, Gibberella species, for example Gibberella zeae Macrophomina species, for example Macrophomina phaseolina, Microdochium species, for example Microdochium nivale, Monographella species, for example Monographella nivalis, Penicillium species, for example Penicillium expansum, Phoma species, for example Phoma lingam, Phomopsis species, for example Phomopsis so ae Phytophthora species, for example Phytophthora cactorum, Pyrenophora species, for example Pyrenophora graminea, Pyricularia species, for example Pyricularia oryzac, Pythium species, for example Pythium ultimum, Rhizoctonia species, for example Rhizoctonia solanv, Rhizopus species, for example Rhizopus oryzae; Sclerotium species, for example Sclerotium rolfsii, Septoria species, for example Septoria nodorum, Typhula species, for example Typhula incarnata, Verticillium species, for example Verticillium dahliae, cancers, galls and witches' broom caused, for example, by Nectria species, for example Nectria galligena, wilt diseases caused, for example, by Verticillium species, for example Verticillium longisporunr, Fusarium species, for example Fusarium oxysporurrv, deformations of leaves, flowers and fruits caused, for example, by Exobasidium species, for example Exobasidium vexans, Taphrina species, for example Taphrina deformans, degenerative diseases in woody plants, caused, for example, by Esca species, for example Phaeomoniella chlamydospora, Phaeoacremonium aleophilum or Fomitiporiamediterranean Ganoderma species, for example Ganoderma boninense, diseases of plant tubers caused, for example, by Rhizoctonia species, for example Rhizoctonia solanv, Helminthosporium species, for example Helminthosporium solanv, diseases caused by bacterial pathogens, for example Xanthomonas species, for example Xanthomonas campestris pv. oryzae, Pseudomonas species, for example Pseudomonas syringae pv. lachrymans, Erwinia species, for example Erwinia amylovora, Liberibacter species, for example Liberibacter asiaticus, Xyella species, for example Xylella fastidiosa, Ralstonia species, for example Ralstonia solanacearum, Dickeya species, for example Dickeya solanv, Clavibacter species, for example Clavibacter michiganensis, Streptomyces species, for example Streptomyces scabies. diseases of soya beans: fungal diseases on leaves, stems, pods and seeds caused, for example, by Alternaria leaf spot (Alternaria spec atrans tenuissima), Anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.j), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), mst (Phakopsora pachyrhizi, Phakopsora meibomiae), scab (Sphaceloma glycines), stemphylium leaf blight (Stemphylium botryosum), sudden death syndrome (Fusarium virguliforme), target spot (Corynespora cassiicola). Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythiumrot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

In some embodiments, the phytopathogenic harmful fungi is selected from Septoria species, Fusarium species, Puccinia species, Erisyphe species, Drechslera species, Ramularia species, Mycosphaerella species and Rhynchosporium species.

In some embodiments, the phytopathogenic harmful fungi is selected from Puccinia recondita, Septoria tritici, Fusarium culmorum, Pyrenophora teres and Rhynchosporium secalis.

In some embodiments, the composition is applied in an amount from about 0.1 L/ha to about 2 L/ha. In some embodiments, the composition is applied in an amount from about 0.4 L/ha to about 1 L/ha.

In some embodiments, the composition is applied in an amount from about 20 g/ha of triazole to about 500 g/ha of triazole. In some embodiments, the composition is applied in an amount from about 100 g/ha of triazole to about 250 g/ha of triazole.

In some embodiments, the triazole fungicide applied in the method disclosed herein is prothioconazole, tebuconazole and any mixture thereof. In some embodiments, the triazole fungicide applied in the method disclosed herein is prothioconazole. In some embodiments, the triazole fungicide applied in the method disclosed herein is tebuconazole.

The present invention also provides use of the composition disclosed herein for controlling and/or preventing pests.

In some embodiments, the pest is phytopathogenic harmful fungi.

The present invention also provides a method for reducing deoxynivalenol (DON) mycotoxin in a field of crop comprising applying an effective amount of the composition comprising:
a) at least one triazole fungicide;
b) a carbonyl containing solvent; and
c) N-alkyl pyrrolidone of formula (I):

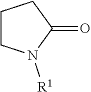

wherein R1 is a straight or branched, saturated or unsaturated, substituted or unsubstituted hydrocarbon group having from 4 to 10 carbon atoms; to a crop infected by fungi of the Fusarium species.

In some embodiments, the crop is selected from the group consisting of wheat, rye, rice, barley, oats, sorghum/millet, triticale, maize, rapeseed, beans, peanuts and sunflowers.

In some embodiments, the crop is wheat.

In some embodiments, the Fusarium specie is Fusarium culmorum.

In a preferred embodiment, the method for reducing deoxynivalenol (DON) mycotoxin in a field of crop comprises applying an effective amount of the composition wherein, the triazole fungicide is prothioconazole, the carbonyl containing solvent is acetophenone and the N-alkyl pyrrolidone is N-octyl pyrrolidone. In a specific embodiment, the amount of prothioconazole is about 20% to about 25% by weight, based on the total weight of the composition. In another specific embodiment, the ratio between acetophenone and the N-octyl pyrrolidone is of 2:1. In a more specific embodiment, the Fusarium specie is Fusarium culmorum and the crop is wheat.

The present invention also provides use of the compositions disclosed herein for reducing deoxynivalenol (DON) mycotoxin in crop infected by fungi of the Fusarium species.

In some embodiments, the Fusarium specie is Fusarium culmorum.

In some embodiments, the crop is selected from the group consisting of wheat, rye, rice, barley, oats, sorghum/millet, triticale, maize, rapeseed, beans, peanuts and sunflowers. In some embodiments, the crop is wheat.

The present invention also provides the compositions comprising:
a) at least one triazole fungicide;
b) a carbonyl containing solvent; and
c) N-alkyl pyrrolidone of formula (I):

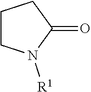

wherein R1 is a straight or branched, saturated or unsaturated, substituted or unsubstituted hydrocarbon group having from 4 to 10 carbon atoms; for use in reducing deoxynivalenol (DON) mycotoxin in crop infected by fungi of the Fusarium species.

In some embodiments, the Fusarium specie is Fusarium culmorum.

In some embodiments, the crop is selected from the group consisting of wheat, rye, rice, barley, oats, sorghum/millet, triticale, maize, rapeseed, beans, peanuts and sunflowers. In some embodiments, the crop is wheat.

In a preferred embodiment, the use for reducing deoxynivalenol (DON) mycotoxin in crop infected by fungi of the Fusarium species comprises applying an effective amount of the composition wherein, the triazole fungicide is prothioconazole, the carbonyl containing solvent is acetophenone and the N-alkyl pyrrolidone is N-octyl pyrrolidone. In a specific embodiment, the amount of prothioconazole is about 20% to about 25% by weight, based on the total weight of the composition. In another specific embodiment, the ratio between acetophenone and the N-octyl pyrrolidone is of 2:1. In a more specific embodiment, the Fusarium specie is Fusarium culmorum and the crop is wheat.

In a different aspect, the invention relates to the use of a combination of a of carbonyl containing solvent with N-alkyl pyrrolidone of formula (I)

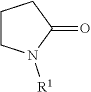

wherein R1 is a straight or branched, saturated or unsaturated, substituted or unsubstituted hydrocarbon group having from 4 to 10 carbon atoms for increasing the efficacy of one or more triazole fungicide.

In some embodiments, the triazole fungicide is selected from azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof. In a preferred embodiment, the triazole fungicide is prothioconazole, tebuconazole and any mixture thereof. In a more preferred embodiment, the triazole fungicide is prothioconazole.

In some embodiments, the combinations of the present invention comprise a carbonyl containing solvent which is selected from the groups of ketones, amides, ureas, esters, lactones, carbonates and any mixtures thereof.

In some embodiments, the ketone solvent is selected from acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctanone, 2,4,6-cycloheptatrien-1-one, acetophenone, propiophenone, 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone, valerophenone and any mixtures thereof. In a preferred embodiment the ketone is cyclohexanone, acetophenone, heptanone and any mixtures thereof. In a more preferred embodiment, the ketone is acetophenone.

In some embodiments, the amide solvent is selected from N-formylmorpholine, N,N-dimethylformamide, N,N-dimethylacetamide, N,N-imethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, 1,3-dimethyl-2-imidazolidinone, 1,3,4-trimethyl-2-imidazolidinone, 1,3-dimethyl-3,4,5,6-tetrahydro-2(1H)pyrimidinone, 1-heptyl-3-methyl-2-imidazolidinone, 1-heptyl-1,3-dihydro-3-methyl-2H-imidazol2-one and any mixture thereof. In a preferred embodiment the amide is N,N-dimethyldecanamide, N,N-dimethyldecenamide, N,N-dimethyl-octanamide and any mixtures thereof.

In some embodiments, the urea solvent is selected from tetramethylurea, tetraethylurea and any mixture thereof.

In some embodiments, the lactone solvent is selected from butyrolactone, alpha-methyl-gamma-butyrolactone, gamma-valerolactone, delta-valerolactone and any mixture thereof.

In some embodiments, the carbonate solvent is selected from dimethyl carbonate, methyl ethyl carbonate, diethyl carbonate, dipropyl carbonate, diisopropyl carbonate, dibutyl carbonate, dipentyl carbonate, dihexyl carbonate, diheptyl carbonate, dioctyl carbonate, dinonyl carbonate, didecyl carbonate, ethylene carbonate, 4-methyl-1,3-dioxolan-2-one, 4-(methoxymethyl)-1,3-dioxolan-2-one, glycerol carbonate, butylene carbonate, 4,6-dimethyl-3-dioxan-2-one, dibenzyl carbonate and any mixture thereof.

In some embodiments, R1 in the N-alkyl pyrrolidone of formula (I) is a hydrocarbon group having from 7 to 9 carbon atoms. In a preferred embodiment, R1 is a hydrocarbon group having 8 carbon atoms.

In a preferred embodiment, the carbonyl containing solvent is acetophenone and the N-alkyl pyrrolidone is N-octyl pyrrolidone.

In some embodiments, the ratio between the carbonyl containing solvent and the N-alkyl pyrrolidone of formula (I) is of about 0.5:1 to about 3:1. In a preferred embodiment, the ratio between the carbonyl containing solvent and the N-alkyl pyrrolidone of formula (I) is of about 1:1 to about 2:1.

In a preferred embodiment, the use of the combination wherein the carbonyl containing solvent is acetophenone and the N-alkyl pyrrolidone is N-octyl pyrrolidone is for increasing the efficacy of prothioconazole. In a more specific embodiment, the ratio between acetophenone and the N-octyl pyrrolidone is of about 2:1.

In a different aspect, the present invention provides an agrochemical composition comprising:
a) at least one triazole fungicide;
b) a carbonyl containing solvent;
c) N-alkyl pyrrolidone of formula (I):

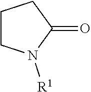

wherein R1 is a straight or branched, saturated or unsaturated, substituted or unsubstituted hydrocarbon group having from 4 to 10 carbon atoms; and
d) an effective amount of compound of formula (II):

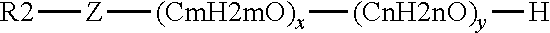

wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atom, m is an integer equal to 2, n is an integer equal to 3, x is an integer of from 3 to 50 and y is an integer of from 0 to 50.

In some embodiments, the triazole fungicide is selected from azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof. In a preferred embodiment, the triazole fungicide is prothioconazole, tebuconazole and any mixture thereof. In a more preferred embodiment, the triazole fungicide is prothioconazole.

In some embodiments, the compositions of the present invention comprise a carbonyl containing solvent which is selected from the groups of ketones, amides, ureas, esters, lactones, carbonates and any mixtures thereof.

In some embodiments, the ketone solvent is selected from acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctanone, 2,4,6-cycloheptatrien-1-one, acetophenone, propiophenone, 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone, valerophenone and any mixtures thereof. In a preferred embodiment the ketone is cyclohexanone, acetophenone, heptanone and any mixtures thereof. In a more preferred embodiment, the ketone is acetophenone.

In some embodiments, the amide solvent is selected from N-formylmorpholine, N,N-dimethylformamide, N,N-dimethylacetamide, N,N-imethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, 1,3-dimethyl-2-imidazolidinone, 1,3,4-trimethyl-2-imidazolidinone, 1,3-dimethyl-3,4,5,6-tetrahydro-2(1H)pyrimidinone, 1-heptyl-3-methyl-2-imidazolidinone, 1-heptyl-1,3-dihydro-3-methyl-2H-imidazol2-one and any mixture thereof. In a preferred embodiment the amide is N,N-dimethyldecanamide, N,N-dimethyldecenamide, N,N-dimethyl-octanamide and any mixtures thereof.

In some embodiments, the urea solvent is selected from tetramethylurea, tetraethylurea and any mixture thereof.

In some embodiments, the lactone solvent is selected from butyrolactone, alpha-methyl-gamma-butyrolactone, gamma-valerolactone, delta-valerolactone and any mixture thereof.

In some embodiments, the carbonate solvent is selected from dimethyl carbonate, methyl ethyl carbonate, diethyl carbonate, dipropyl carbonate, diisopropyl carbonate, dibutyl carbonate, dipentyl carbonate, dihexyl carbonate, diheptyl carbonate, dioctyl carbonate, dinonyl carbonate, didecyl carbonate, ethylene carbonate, 4-methyl-1,3-dioxolan-2-one, 4-(methoxymethyl)-1,3-dioxolan-2-one, glycerol carbonate, butylene carbonate, 4,6-dimethyl-3-dioxan-2-one, dibenzyl carbonate and any mixture thereof.

In some embodiments, R1 in the N-alkyl pyrrolidone of formula (I) is a hydrocarbon group having from 7 to 9 carbon atoms. In a preferred embodiment, R1 is a hydrocarbon group having 8 carbon atoms.

In some embodiments, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 50 and y is an integer of from 0 to 50.

In some embodiments, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 10 and y is an integer of from 3 to 9.

In some embodiments, R2 in compound of formula (II) is linear or branched, saturated or unsaturated alkyl radical having from 16 to 18 carbon atoms, Z is an oxygen atom m is an integer equal to 2, n is an integer equal to 3, x is an integer of from 5 to 10 and y is an integer of from 4 to 9.

In some embodiments, R2 in compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 0 to 50.

In some embodiments, R2 in compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 3 to 50.

In some embodiments, R2 in compound of formula (II) is linear or branched, saturated or unsaturated acyl radical having from 16 to 18 carbon atoms, Z is an oxygen atom, m is an integer equal to 2, n is an integer equal to 3, x is an integer of from 3 to 40 and y is an integer of from 0 to 20.

In some embodiments, R2 in compound of formula (II) is linear or branched, saturated or unsaturated acyl radical having from 16 to 18 carbon atoms, Z is a nitrogen atom, m is an integer equal to 2, n is an integer equal to 3, x is an integer of 20 to 40 and y is an integer of 0.

Suitable examples for compounds of formula (II) include but are not limited to Ethylan™ 995 (Akzo Nobel Agrochemicals), Agnique® BP420 (BASF), Agnique® 420 (BASF), Brij™ CS17 (Croda), Atplus™ PFA (Croda), Synergen® Soc (Clariant), Genapol® C-100 (Clariant), Atplus™ 242-SO-(CQ) (Croda), Lutensol® AT types (BASF) such as Lutensol® AT 11, Lutensol® AT 18, Lutensol® AT 25 E, Lutensol® AT 50 E; Lutensol® FA 12 K (BASF), Lutensol® FA 12 (BASF), Araphen® K 100 (BASF), Agnique® CSO-20 (BASF), Agnique® CSO-35 (BASF), Agnique® CSO-40 (BASF), Emulan® A (BASF).

In some embodiments, the composition described herein contains compound of formula (II) in amount equal to or above about 9% based on the total weight of the composition. In a preferred embodiment, the amount is equal to or above about 12% based on the total weight of the composition.

The compositions described herein contain different ratios between the carbonyl containing solvent and the N-alkyl pyrrolidone of formula (I).

In some embodiments, the ratio between the carbonyl containing solvent and the N-alkyl pyrrolidone of formula (I) is of about 0.5:1 to about 3:1. In a preferred embodiment, the ratio between the carbonyl containing solvent and the N-alkyl pyrrolidone of formula (I) is of about 1:1 to about 2:1.

In some embodiments, the amount of triazole fungicide in the composition is about 0.1% to about 50% by weight, based on the total weight of the composition. In a preferred embodiment, the amount of triazole fungicide in the composition is about 10% to about 30% by weight, based on the total weight of the composition. In a more preferred embodiment, the amount of triazole fungicide in the composition is about 20% to about 25% by weight, based on the total weight of the composition. In a specially preferred embodiment, the amount of triazole fungicide in the composition is of about 25% weight, based on the total weight of the composition.

In a preferred embodiment, the carbonyl containing solvent is acetophenone and the N-alkyl pyrrolidone is N-octyl pyrrolidone.

In a preferred embodiment, the triazole fungicide is prothioconazole, the carbonyl containing solvent is acetophenone and the N-alkyl pyrrolidone is N-octyl pyrrolidone.

In a preferred embodiment, the triazole fungicide is prothioconazole, the carbonyl containing solvent is acetophenone and the N-alkyl pyrrolidone is N-octyl pyrrolidone wherein the ratio between the carbonyl containing solvent and the N-octyl pyrrolidone is of about 2:1.

In a preferred embodiment, the triazole is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 50 and y is an integer of from 0 to 50. In specific embodiment, the amount of prothioconazole is about 20% to about 25% by weight, based on the total weight of the composition. In another specific embodiment, the ratio between acetophenone and N-octyl pyrrolidone is of 2:1. In another specific embodiment, compound of formula (II) is in amount equal to or above about 9% based on the total weight of the composition. In another specific embodiment, compound II is in amount equal to or above about 12% based on the total weight of the composition.

In a preferred embodiment, the triazole fungicide is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 10 and y is an integer of from 3 to 9. In specific embodiment, the amount of prothioconazole is about 20% to about 25% by weight, based on the total weight of the composition. In another specific embodiment, the ratio between acetophenone and N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition.

In a preferred embodiment, the triazole fungicide is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is an oxygen atom, m is an integer equal to 2, n is an integer equal to 3, x is an integer of from 5 to 10 and y is an integer of from 4 to 9. In specific embodiment, the amount of prothioconazole is about 20% to about 25% by weight, based on the total weight of the composition. In another specific embodiment, the ratio between acetophenone and N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition.

In a preferred embodiment, the triazole fungicide is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 0 to 50. In specific embodiment, the amount of prothioconazole is about 20% to about 25% by weight, based on the total weight of the composition. In another specific embodiment, the ratio between acetophenone and N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition.

In a preferred embodiment, the triazole fungicide is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 3 to 50. In specific embodiment, the amount of prothioconazole is about 20% to about 25% by weight, based on the total weight of the composition. In another specific embodiment, the ratio between acetophenone and N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition.

In a preferred embodiment, the triazole fungicide is prothioconazole, the carbonyl containing solvent is acetophenone, the N-alkyl pyrrolidone is N-octyl pyrrolidone and compound of formula (II) is linear or branched, saturated or unsaturated acyl radical having from 16 to 18 carbon atoms, Z is an oxygen atom, m is an integer equal to 2, n is an integer equal to 3, x is an integer of from 3 to 40 and y is an integer of from 0 to 20. In specific embodiment, the amount of prothioconazole is about 20% to about 25% by weight, based on the total weight of the composition. In another specific embodiment, the ratio between acetophenone and N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition.

In a preferred embodiment, the triazole fungicide is prothioconazole, the carbonyl containing solvent is acetophenone, the N-alkyl pyrrolidone is N-octyl pyrrolidone and compound of formula (II) is linear or branched, saturated or unsaturated acyl radical having from 16 to 18 carbon atoms, Z is a nitrogen atom, m is an integer equal to 2, n is an integer equal to 3, x is an integer of 20 to 40 and y is an integer of 0. In specific embodiment, the amount of prothioconazole is about 20% to about 25% by weight, based on the total weight of the composition. In another specific embodiment, the ratio between acetophenone and N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition.

The present invention also provides a method for controlling and/or preventing pests comprising applying an effective amount of the composition disclosed herein to a locus where the pest is to be controlled and/or prevented so as to thereby control and/or prevent the pest.

In some embodiments, the pest is a phytopathogenic harmful fungi.

In some embodiments, the locus where the pest is to be controlled and/or prevented is a crop field.

The present invention also provides a method for controlling and/or preventing phytopathogenic harmful fungi comprising applying an effective amount of the composition disclosed herein to a locus where the phytopathogenic harmful fungi is to be controlled so as to thereby control the phytopathogenic harmful fungi.

The present invention also provides a method of controlling phytopathogenic harmful fungi in a field of crop comprising applying an effective amount of the composition disclosed herein to a field of crop so as to thereby control the phytopathogenic harmful fungi in the field of crop.

In some embodiments, the crop is selected from the group consisting of cotton, flax, grapevines, fruit, vegetables, such as Rosaceae sp. (for example pome fruit such as apples and pears, but also stone fruit such as apricots, cherries, almonds and peaches, and berry fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, organs and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumbers), Alliaceae sp. (for example leeks, onions), Papilionaceae sp. (for example peas); main crop plants such as Gramineae sp. (for example maize, turfgrass, cereals such as wheat, rye, rice, barley, oats, sorghum/millet and triticale), Asteraceae sp. (for example sunflowers), Brassicaceae sp. (for example white cabbage, red cabbage, broccoli, cauliflower, Brussels sprouts, Pak Choi, kohlrabi, radishes, and rapeseed, mustard, horseradish and cress), Fabacae sp. (for example beans, peanuts), Papilionaceae sp. (for example soya beans), Solanaceae sp. (for example potatoes), Chenopodiaceae sp. (for example sugar beet, fodder beet, chard, beetroot); sugarcane, poppies, olives, coconuts, cocoa, tobacco and useful plants and ornamental plants in gardens and forests; and genetically modified varieties of each of these plants, and the seeds of these plants. In a preferred embodiment, the crop is selected from the group consisting of wheat, rye, rice, barley, oats, sorghum/millet, triticale, maize, rapeseed, beans, peanuts and sunflowers. In a more preferred embodiment, the crop is selected from the group consisting of wheat, rye, rice, barley, oats, sorghum/millet and triticale.

Non-limiting examples of pathogens of fungal diseases which may be treated in accordance with the invention include: diseases caused by powdery mildew pathogens, for example Blumeria species, for example Blumeria graminis, Podosphaera species, for example Podosphaera leucotricha, Sphaerotheca species, for example Sphaerotheca fuliginea, Uncinula species, for example Uncinula necator, for example Erysiphe species; diseases caused by rust disease pathogens, for example Gymnosporangium species, for example Gymnosporangium sabinae; Hemileia species, for example Hemileia vastatrix; Phakopsora species, for example Phakopsora pachyrhizi or Phakopsora meibomiae Puccinia species, for example Puccinia recondita, Puccinia graminis oder Puccinia striif ormis, Uromyces species, for example Uromyces appendiculatus, diseases caused by pathogens from the group of the Oomycetes, for example Albugo species, for example Albugo Candida, Bremia species, for example Bremia laciucaer, Peronospora species, for example Peronospora pisi or P. brassicaer, Phytophthora species, for example Phytophthora infestans, Plasmopara species, for example Plasmopara viticola, Pseudoperonospora species, for example Pseudoperonospora humuli or Pseudoperonospora cubensis, Pythium species, for example Pythium ultimunv, leaf blotch diseases and leaf wilt diseases caused, for example, by Alternaria species, lor example Alternaria solanv, Cercospora species, for example Cercospora beticola, Cladiosporium species, for example Cladiosporium cucumerinunr, Cochliobolus species, for example Cochliobolus sativus (conidial form: Drechslera, syn: Helminthosporium) or Cochliobolus miyabeanus, Colletotrichum species, for example Colletotrichum lindemuthaniunv, Corynespora species, for example Corynespora cassiicola, Cycloconium species, for example Cycloconium oleaginunv, Diaporthe species, for example Diaporthe citrv, Elsinoe species, for example Elsinoe fawcettii, Gloeosporium species, for example Gloeosporium laeticolor, Glomerella species, for example Glomerella cingulata, Guignardia species, for example Guignardia bidwellv, Leptosphaeria species, for example Leptosphaeria maculans, Magnaporthe species, for example Magnaporthe grisea, Microdochium species, for example Microdochium nivaler, Mycosphaerella species, for example Mycosphaerella graminicola (also known as Septoria tritici), Mycosphaerella arachidicola or Mycosphaerella fi j iens, Phaeosphaeria species, for example Phaeosphaeria nodorunr, Pyrenophora species, for example Pyrenophora teres or Pyrenophora tritici rep enth, Ramularia species, for example Ramularia collo-cygni or Ramularia areola, Rhynchosporium species, for example Rhynchosporium secalis, Septoria species, for example Septoria apii or Septoria lycopersicv, Stagonospora species, for example Stagonospora nodorunr, Typhula species, for example Typhula incarnata, Venturia species, for example Venturia inaequal, root and stem diseases caused, for example, by Corticium species, for example Corticium graminearum, Fusarium species, for example Fusarium oxysporum Gaeumannomyces species, for example Gaeumannomyces graminis, Plasmodiophora species, for example Plasmodiophora brassica, Rhizoctonia species, for example Rhizoctonia solani, Sarocladium species, for example Sarocladium oryzae; Sclerotium species, for example Sclerotium oryzae, Tapesia species, for example Tapesia acuf ormis, Thielaviopsis species, for example Thielaviopsis basicola, ear and panicle diseases (including com cobs) caused, for example, by Alternaria species, for example Alternaria spp.; Aspergillus species, for example Aspergillus flavus, Cladosporium species, for example Cladosporium cladosporioides, Claviceps species, for example Claviceps purpurea, Fusarium species, for example Fusarium culmorunr, Gibberella species, for example Gibberella zeae Monographella species, for example Monographella nivalis, Stagnospora species, for example Stagnospora nodorunr, diseases caused by smut fungi, for example Sphacelotheca species, for example Sphacelotheca reiliana, Tilletia species, for example Tilletia caries or Tilletia controversy, Urocystis species, for example Urocystis occulta, Ustilago species, for example Ustilago nuda, fruit rot caused, for example, by Aspergillus species, for example Aspergillus flavus, Botrytis species, for example Botrytis cinerea, Monilinia species, for example Monilinia Iαχα, Penicillium species, for example Penicillium expansum or Penicillium purpurogenum, Rhizopus species, for example Rhizopus stolonifer, Sclerotinia species, for example Sclerotinia sclerotiorum, Verticilium species, for example Verticilium alboatrum, seed- and soil-borne rot and wilt diseases, and also diseases of seedlings, caused, for example, by Alternaria species, for example Alternaria brasside ola Aphanomyces species, for example Aphanomyces euteiches, Ascochyta species, for example Ascochyta lends, Aspergillus species, or example Aspergillus flavus, Cladosporium species, for example Cladosporium herbarum, Cochliobolus species, for example Cochliobolus sativus (conidial form: Drechslera, Bipolaris Syn: Helminthosporium), Colletotrichum species, for example Colletotrichum coccodes, Fusarium species, for example Fusarium culmorum, Gibberella species, for example Gibberella zeae Macrophomina species, for example Macrophomina phaseolina, Microdochium species, for example Microdochium nivale, Monographella species, for example Monographella nivalis, Penicillium species, for example Penicillium expansum, Phoma species, for example Phoma lingam, Phomopsis species, for example Phomopsis so ae Phytophthora species, for example Phytophthora cactorum, Pyrenophora species, for example Pyrenophora graminea, Pyricularia species, for example Pyricularia oryzac, Pythium species, for example Pythium ultimum, Rhizoctonia species, for example Rhizoctonia solanv, Rhizopus species, for example Rhizopus oryzae; Sclerotium species, for example Sclerotium rolfsii, Septoria species, for example Septoria nodorum, Typhula species, for example Typhula incarnata, Verticillium species, for example Verticillium dahliae, cancers, galls and witches' broom caused, for example, by Nectria species, for example Nectria galligena, wilt diseases caused, for example, by Verticillium species, for example Verticillium longisporunr, Fusarium species, for example Fusarium oxysporurrv, deformations of leaves, flowers and fruits caused, for example, by Exobasidium species, for example Exobasidium vexans, Taphrina species, for example Taphrina deformans, degenerative diseases in woody plants, caused, for example, by Esca species, for example Phaeomoniella chlamydospora, Phaeoacremonium aleophilum or Fomitiporiamediterranean Ganoderma species, for example Ganoderma boninense, diseases of plant tubers caused, for example, by Rhizoctonia species, for example Rhizoctonia solanv, Helminthosporium species, for example Helminthosporium solanv, diseases caused by bacterial pathogens, for example Xanthomonas species, for example Xanthomonas campestris pv. oryzae, Pseudomonas species, for example Pseudomonas syringae pv. lachrymans, Erwinia species, for example Erwinia amylovora, Liberibacter species, for example Liberibacter asiaticus, Xyella species, for example Xylella fastidiosa, Ralstonia species, for example Ralstonia solanacearum, Dickeya species, for example Dickeya solanv, Clavibacter species, for example Clavibacter michiganensis, Streptomyces species, for example Streptomyces scabies. diseases of soya beans: fungal diseases on leaves, stems, pods and seeds caused, for example, by Alternaria leaf spot (Alternaria spec atrans tenuissima), Anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.j), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), mst (Phakopsora pachyrhizi, Phakopsora meibomiae), scab (Sphaceloma glycines), stemphylium leaf blight (Stemphylium botryosum), sudden death syndrome (Fusarium virguliforme), target spot (Corynespora cassiicola). Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythiumrot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

The phytopathogenic harmful fungi is selected from Septoria species, Fusarium species, Puccinia species, Erisyphe species, Drechslera species, Ramularia species, Mycosphaerella species and Rhynchosporium species.

In some embodiments, the phytopathogenic harmful fungi is selected from Puccinia recondita, Septoria tritici, Fusarium culmorum, Pyrenophora teres and Rhynchosporium secalis.

In some embodiments, the composition is applied in an amount from about 0.1 L/ha to about 2 L/ha. In some embodiments, the composition is applied in an amount from about 0.4 L/ha to about 1 L/ha.

In some embodiments, the composition is applied in an amount from about 20 g/ha of triazole to about 500 g/ha of triazole. In some embodiments, the composition is applied in an amount from about 100 g/ha of triazole to about 250 g/ha of triazole.

In some embodiments, the triazole in the composition is prothioconazole.

The present invention also provides use of the composition disclosed herein for controlling and/or preventing pests.

The present invention also provides use of the composition disclosed herein for controlling phytopathogenic harmful fungi.

The present invention also provides the compositions disclosed herein for use in controlling and/or preventing pests.

The present invention also provides the compositions disclosed herein for use in controlling phytopathogenic harmful fungi.

The present invention also provides a method for reducing deoxynivalenol (DON) mycotoxin in a field of crop comprising applying an effective amount of the compositions disclosed herein to a crop infected by fungi of the Fusarium species.

In some embodiments, the crop is selected from the group consisting of wheat, rye, rice, barley, oats, sorghum/millet, triticale, maize, rapeseed, beans, peanuts and sunflowers.

In some embodiments, the crop is wheat.

In some embodiments, the Fusarium specie is Fusarium culmorum.

The present invention also provides use of the compositions disclosed herein for reducing deoxynivalenol (DON) mycotoxin in crop infected by fungi of the Fusarium species.

In some embodiments, the Fusarium specie is Fusarium culmorum.

In some embodiments, the crop is selected from the group consisting of wheat, rye, rice, barley, oats, sorghum/millet, triticale, maize, rapeseed, beans, peanuts and sunflowers.

In some embodiments, the crop is wheat.

The present invention also provides the compositions disclosed herein for use in reducing deoxynivalenol (DON) mycotoxin in crop infected by fungi of the Fusarium species.

In some embodiments, the Fusarium specie is Fusarium culmorum.

In some embodiments, the crop is selected from the group consisting of wheat, rye, rice, barley, oats, sorghum/millet, triticale, maize, rapeseed, beans, peanuts and sunflowers.

In some embodiments, the crop is wheat.

In different aspect the present invention provides the use of a compound of formula (II):

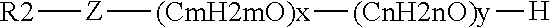

wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atom, m is an integer equal to 2, n is an integer equal to 3, x is an integer of from 3 to 50 and y is an integer of from 0 to 50, for increasing the efficacy of one or more triazole fungicide.

In some embodiments, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 50 and y is an integer of from 0 to 50.

In some embodiments, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 10 and y is an integer of from 3 to 9.

In some embodiments, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 5 to 10 and y is an integer of from 4 to 9.

In some embodiments, R2 in compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 0 to 50.

In some embodiments, R2 in compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 3 to 50.

In some embodiments, R2 in compound of formula (II) is linear or branched, saturated or unsaturated acyl radical having from 16 to 18 carbon atoms, Z is an oxygen atom, m is an integer equal to 2, n is an integer equal to 3, x is an integer of from 3 to 40 and y is an integer of from 0 to 20.

In some embodiments, R2 in compound of formula (II) is linear or branched, saturated or unsaturated acyl radical having from 16 to 18 carbon atoms, Z is a nitrogen atom, m is an integer equal to 2, n is an integer equal to 3, x is an integer of 20 to 40 and y is an integer of 0.

In some embodiments, the amount of compound of formula (II) is equal to or above about 9% based on the total weight of the composition. In some embodiments, the amount of compound of formula (II) is equal to or above about 12% based on the total weight of the composition.

In some embodiments, the triazole fungicide is selected from azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof. In some embodiments, the triazole fungicide is prothioconazole or tebuconazole. In some embodiments, the triazole fungicide is prothioconazole.

In some preferred embodiments, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 50 and y is an integer of from 0 to 50, wherein compound of formula (II) is used for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

In some embodiments, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 10 and y is an integer of from 3 to 9, wherein compound of formula (II) is used for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

In some embodiments, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 5 to 10 and y is an integer of from 4 to 9, wherein compound of formula (II) is used for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

In some embodiments, R2 in compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 0 to 50, wherein compound of formula (II) is used for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

In some embodiments, R2 in compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 3 to 50, wherein compound of formula (II) is used for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

In some embodiments, R2 in compound of formula (II) is linear or branched, saturated or unsaturated acyl radical having from 16 to 18 carbon atoms, Z is an oxygen atom, m is an integer equal to 2, n is an integer equal to 3, x is an integer of from 3 to 40 and y is an integer of from 0 to 20, wherein compound of formula (II) is used for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

In some embodiments, R2 in compound of formula (II) is linear or branched, saturated or unsaturated acyl radical having from 16 to 18 carbon atoms, Z is a nitrogen atom, m is an integer equal to 2, n is an integer equal to 3, x is an integer of 20 to 40 and y is an integer of 0, wherein compound of formula (II) is used for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

The present invention also provides with a method of treating plants or plants parts with a composition comprising of one or more triazole fungicide with compound of formula (II):

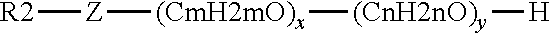

wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atoms, m is an integer equal to 2, n is an integer equal to 3, x is an integer of from 3 to 50 and y is an integer of from 0 to 50, wherein the compound of formula (II) is for increasing the efficacy of the one or more triazole(s).

In some embodiments, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 50 and y is an integer of from 0 to 50.

In some embodiments, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 10 and y is an integer of from 3 to 9.

In some embodiments, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 5 to 10 and y is an integer of from 4 to 9.

In some embodiments, R2 in compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 0 to 50.

In some embodiments, R2 in compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 3 to 50.

In some embodiments, R2 in compound of formula (II) is linear or branched, saturated or unsaturated acyl radical having from 16 to 18 carbon atoms, Z is an oxygen atom, m is an integer equal to 2, n is an integer equal to 3, x is an integer of from 3 to 40 and y is an integer of from 0 to 20.

In some embodiments, R2 in compound of formula (II) is linear or branched, saturated or unsaturated acyl radical having from 16 to 18 carbon atoms, Z is a nitrogen atom, m is an integer equal to 2, n is an integer equal to 3, x is an integer of 20 to 40 and y is an integer of 0.

In some embodiments, the amount of compound of formula (II), in the method disclosed herein, is equal to or above about 9% based on the total weight of the composition. In some embodiments, the amount of compound of formula (II), in the method disclosed herein, is equal to or above about 12% based on the total weight of the composition.

In some embodiments, the triazole fungicide is selected from azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof. In some embodiments, the triazole fungicide is prothioconazole or tebuconazole. In some embodiments, the triazole fungicide is prothioconazole.

In some preferred embodiments, in the method disclosed herein, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 50 and y is an integer of from 0 to 50, wherein compound of formula (II) is for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

In some embodiments, in the method disclosed herein, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 10 and y is an integer of from 3 to 9, wherein compound of formula (II) is for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

In some embodiments, in the method disclosed herein, R2 in compound of formula (II) is linear or branched, saturated or unsaturated alkyl radical having from 16 to 18 carbon atoms, Z is an oxygen atom, m is an integer equal to 2, n is an integer equal to 3, x is an integer of from 5 to 10 and y is an integer of from 4 to 9, wherein compound of formula (II) is for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition. In some embodiments, in the method disclosed herein, R2 in compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 0 to 50, wherein compound of formula (II) is for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

In some embodiments, in the method disclosed herein, R2 in compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 3 to 50, wherein compound of formula (II) is for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

In some embodiments, in the method disclosed herein, R2 in compound of formula (II) is linear or branched, saturated or unsaturated acyl radical having from 16 to 18 carbon atoms, Z is an oxygen atom, m is an integer equal to 2, n is an integer equal to 3, x is an integer of from 3 to 40 and y is an integer of from 0 to 20, wherein compound of formula (II) is for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

In some embodiments, in the method disclosed herein, R2 in compound of formula (II) is linear or branched, saturated or unsaturated acyl radical having from 16 to 18 carbon atoms, Z is a nitrogen atom, m is an integer equal to 2, n is an integer equal to 3, x is an integer of 20 to 40 and y is an integer of 0, wherein compound of formula (II) is for increasing the efficacy of prothioconazole. In a specific embodiment, the amount of compound of formula (II) is equal to or above about 9% based on the total weight of the composition. In another specific embodiment, the amount of compound of formula (II) is equal to or above about 12% based on the total weight of the composition.

The present invention also provides a method for reducing deoxynivalenol (DON) mycotoxin in a field of crop comprising applying an effective amount of the composition comprising:
a) at least one triazole fungicide;
b) a carbonyl containing solvent;
c) N-alkyl pyrrolidone of formula (I):

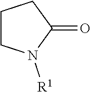

wherein R1 is a straight or branched, saturated or unsaturated, substituted or unsubstituted hydrocarbon group having from 4 to 10 carbon atoms; and
d) an effective amount of compound of formula (II):

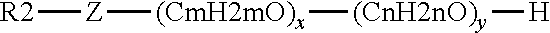

wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atom, m is an integer equal to 2, n is an integer equal to 3, x is an integer of from 3 to 50 and y is an integer of from 0 to 50, to a crop infected by fungi of the Fusarium species.

In some embodiments, the crop is selected from the group consisting of wheat, rye, rice, barley, oats, sorghum/millet, triticale, maize, rapeseed, beans, peanuts and sunflowers.

In some embodiments, the crop is wheat.

In some embodiments, the Fusarium specie is Fusarium culmorum.

In a preferred embodiment, the method for reducing deoxynivalenol (DON) mycotoxin in a field of crop comprises applying an effective amount of the composition wherein, the triazole is prothioconazole, the carbonyl containing solvent is acetophenone, the N-alkyl pyrrolidone is N-octyl pyrrolidone and compound II is linear or branched, saturated or unsaturated alkyl radical having from 16 to 18 carbon atoms, Z is an oxygen atom, m is an integer equal to 2, n is an integer equal to 3, x is an integer of from 3 to 50 and y is an integer of from 0 to 50. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound II is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In a preferred embodiment, the method for reducing deoxynivalenol (DON) mycotoxin in a field of crop comprises applying an effective amount of the composition wherein, the triazole is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 10 and y is an integer of from 3 to 9. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In a preferred embodiment, the method for reducing deoxynivalenol (DON) mycotoxin in a field of crop comprises applying an effective amount of the composition wherein, the triazole is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is an oxygen atom, m is an integer equal to 2, n is an integer equal to 3, x is an integer of from 5 to 10 and y is an integer of from 4 to 9. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound II is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In a preferred embodiment, the method for reducing deoxynivalenol (DON) mycotoxin in a field of crop comprises applying an effective amount of the composition wherein, the triazole is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 0 to 50. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In a preferred embodiment, the method for reducing deoxynivalenol (DON) mycotoxin in a field of crop comprises applying an effective amount of the composition wherein, the triazole is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 3 to 50. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound II is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In a preferred embodiment, the method for reducing deoxynivalenol (DON) mycotoxin in a field of crop comprises applying an effective amount of the composition wherein, the triazole is prothioconazole, the carbonyl containing solvent is acetophenone, the N-alkyl pyrrolidone is N-octyl pyrrolidone and compound of formula (II) is linear or branched, saturated or unsaturated acyl radical having from 16 to 18 carbon atoms, Z is an oxygen atom, m is an integer equal to 2, n is an integer equal to 3, x is an integer of from 3 to 40 and y is an integer of from 0 to 20. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound II is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In preferred embodiment, the method for reducing deoxynivalenol (DON) mycotoxin in a field of crop comprises applying an effective amount of the composition wherein, the triazole is prothioconazole, the carbonyl containing solvent is acetophenone, the N-alkyl pyrrolidone is N-octyl pyrrolidone and compound of formula (II) is linear or branched, saturated or unsaturated acyl radical having from 16 to 18 carbon atoms, Z is a nitrogen atom, m is an integer equal to 2, n is an integer equal to 3, x is an integer of 20 to 40 and y is an integer of 0. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound II is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

The present invention also provides use of the compositions comprising:
a) at least one triazole fungicide;
b) a carbonyl containing solvent;
c) N-alkyl pyrrolidone of formula (I):

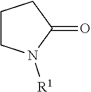

wherein R1 is a straight or branched, saturated or unsaturated, substituted or unsubstituted hydrocarbon group having from 4 to 10 carbon atoms; and
d) an effective amount of compound of formula (II):

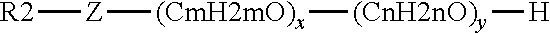

wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atom, m is an integer equal to 2, n is an integer equal to 3, x is an integer of from 3 to 50 and y is an integer of from 0 to 50, for reducing deoxynivalenol (DON) mycotoxin in crop infected by fungi of the Fusarium species.

In some embodiments, the Fusarium specie is Fusarium culmorum.

In some embodiments, the crop is selected from the group consisting of wheat, rye, rice, barley, oats, sorghum/millet, triticale, maize, rapeseed, beans, peanuts and sunflowers.

In some embodiments, the crop is wheat.

The present invention also provides the compositions disclosed herein for use in reducing deoxynivalenol (DON) mycotoxin in crop infected by fungi of the Fusarium species.

In some embodiments, the Fusarium specie is Fusarium culmorum.

In some embodiments, the crop is selected from the group consisting of wheat, rye, rice, barley, oats, sorghum/millet, triticale, maize, rapeseed, beans, peanuts and sunflowers.

In some embodiments, the crop is wheat.

In preferred embodiment, the use for reducing deoxynivalenol (DON) mycotoxin in crop infected by fungi of the Fusarium species comprises applying an effective amount of the composition wherein, the triazole is prothioconazole, the carbonyl containing solvent is acetophenone, the N-alkyl pyrrolidone is N-octyl pyrrolidone and compound II is linear or branched, saturated or unsaturated alkyl radical having from 16 to 18 carbon atoms, Z is an oxygen atom, m is an integer equal to 2, n is an integer equal to 3, x is an integer of from 3 to 50 and y is an integer of from 0 to 50. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound II is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In preferred embodiment, the use for reducing deoxynivalenol (DON) mycotoxin in crop infected by fungi of the Fusarium species wherein, the triazole is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is an oxygen atom, m is an integer equal to 2, n is an integer equal to 3, x is an integer of from 3 to 10 and y is an integer of from 3 to 9. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In preferred embodiment, the use for reducing deoxynivalenol (DON) mycotoxin in crop infected by fungi of the Fusarium species wherein, the triazole is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is an oxygen atom, m is an integer equal to 2, n is an integer equal to 3, x is an integer of from 5 to 10 and y is an integer of from 4 to 9. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In preferred embodiment, the use for reducing deoxynivalenol (DON) mycotoxin in crop infected by fungi of the Fusarium species wherein, the triazole is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 0 to 50. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In preferred embodiment, the use for reducing deoxynivalenol (DON) mycotoxin in crop infected by fungi of the Fusarium species wherein, the triazole is prothioconazole, the carbonyl containing solvent is acetophenone, the N-alkyl pyrrolidone is N-octyl pyrrolidone and compound of formula (II) is linear or branched, saturated or unsaturated alkyl radical having from 16 to 18 carbon atoms, Z is a nitrogen atom, m is an integer equal to 2, n is an integer equal to 3, x is an integer of from 3 to 50 and y is an integer of from 3 to 50. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In preferred embodiment, the use for reducing deoxynivalenol (DON) mycotoxin in crop infected by fungi of the Fusarium species wherein, the triazole is prothioconazole, the carbonyl containing solvent is acetophenone, the N-alkyl pyrrolidone is N-octyl pyrrolidone and compound of formula (II) is linear or branched, saturated or unsaturated acyl radical having from 16 to 18 carbon atoms, Z is an oxygen atom, m is an integer equal to 2, n is an integer equal to 3, x is an integer of from 3 to 40 and y is an integer of from 0 to 20. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound of formula (II) is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

In preferred embodiment, the use for reducing deoxynivalenol (DON) mycotoxin in crop infected by fungi of the Fusarium species wherein, the triazole is prothioconazole, the carbonyl containing solvent is acetophenone, the N-alkyl pyrrolidone is N-octyl pyrrolidone and compound of formula (II) is linear or branched, saturated or unsaturated acyl radical having from 16 to 18 carbon atoms, Z is a nitrogen atom, m is an integer equal to 2, n is an integer equal to 3, x is an integer of 20 to 40 and y is an integer of 0. In specific embodiment, the amount of prothioconazole is about 20% to about 25% by weight, based on the total weight of the composition. In another specific embodiment, the ratio between acetophenone and the N-octyl pyrrolidone is of 2:1. In another specific embodiment, compound II is in amount equal to or above about 9% based on the total weight of the composition. In another specific embodiment, compound of formula (II) is in amount equal to or above about 12% based on the total weight of the composition. In a more specific embodiment, the Fusarium specie is Fusarium culmorum and the crop is wheat.

All the compositions and/or combinations of the invention are liquid compositions. These compositions include the following formulation types: DC (GCPF formulation code for dispersible concentrate); EC (GCPF formulation code for emulsion concentrate); EW (GCPF formulation code for oil-in-water emulsion); ES (GCPF formulation code for emulsion for seed treatment), FS (GCPF formulation code for multiphase concentrate for seed treatment), EO (GCPF formulation code for water-in-oil emulsion; ME (GCPF formulation code for microemulsion; SE (GCPF formulation code for suspoemulsion); SL (GCPF formulation code for water-soluble concentrate); CS (GCPF formulation code for capsule suspension) and AL (GCPF formulation code for ready-to-use liquid formulation, other liquids for undiluted application). Particular preference is given to emulsion concentrates (EC formulation type). An emulsion concentrate is typically understood to mean a composition that forms an oil-in-water emulsion when mixed with water. The emulsion is typically formed spontaneously. The concentrate preferably takes the form of a homogeneous solution. It is typically virtually free of dispersed particles. More particularly, the formulations of the invention provide stable emulsion concentrate formulations of triazoles, optionally in combination with further organic, water-insoluble active ingredients, preferably selected from fungicides and insecticides, for treatment of plants.

All the compositions and/or combinations of the invention may comprise further one or more active fungicidal, insecticidal or herbicidal ingredients. Preferably, the compositions of the invention comprise one or more active insecticidal or fungicidal ingredients, more preferably one or more active fungicidal ingredients.

Preferred insecticidal components are, for example, imidacloprid, nitenpyram, acetamiprid, thiacloprid, thiamethoxam, clothianidin, cyantraniliprole, chlorantraniliprole, flubendiamide, tetraniliprole, cyclaniliprole, spirodiclofen, spiromesifen, spirotetramat, abamectin, acrinathrin, chlorfenapyr, emamectin, ethiprole, fipronil, flonicamid, flupyradifurone, indoxacarb, metaflumizone, methoxyfenozid, milbemycin, pyridaben, pyridalyl, silafluofen, spinosad, sulfoxaflor and triflumuron.

Preferred fungicidal components are, for example, bixafen, fenamidone, fenhexamid, fluopicolide, fluopyram, fluoxastrobin, iprovalicarb, isotianil, isopyrazam, pencycuron, penflufen, propineb, trifloxystrobin, ametoctradin, amisulbrom, azoxystrobin, benthiavalicarb-isopropyl, benzovindiflupyr, boscalid, carbendazim, chlorothanonil, cyazofamid, cyflufenamid, cymoxanil, cyproconazole, difenoconazole, ethaboxam, epoxiconazole, famoxadone, fluazinam, fluquinconazole, flusilazole, flutianil, fluxapyroxad, isopyrazam, kresoxim methyl, mancozeb, mandipropamid, metconazol, pyriofenone, folpet, metaminostrobin, oxathiapiprolin, penthiopyrad, picoxystrobin, probenazole, proquinazid, pydiflumetofen, pyraclostrobin, sedaxane, spiroxamin, tebufloquin, tetraconazole, valiphenalate, zoxamide, ziram, N-(5-chloro-2-isopropylbenzyl)-N-cyclopropyl-3(difluoromethyl)-5-fluoro-1-methyl-iH-pyrazole-4-carboxamide, N-(5-chloro-2-isopropylbenzyl)-N-5 cyclopropyl-3-(difluoromethyl)-5-fluoro-1-methyl-iH-pyrazole-4-carboxamide, 2-{3-[2-(1-{[3,5bis(difluoromethyl)-1H-pyrazol-1-yl]acetyl}piperidin-4-yl)-1,3-thiazol-4-yl]-4,5-dihydro-1,2-oxazol-5yl}phenyl methanesulfonate, 2-{3-[2-(1-{[3,5-bis(difluoromethyl)-1H-pyrazol-1-yl]acetyl}piperidin-4yl)-1,3-thiazol-4-yl]-4,5-dihydro-1,2-oxazol-5-yl}-3-chlorophenylmethane-sulfonate, (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate (lyserphenvalpyr).

Particularly preferred fungicidal mixing partners for prothioconazole are, for example: spiroxamin, bixafen, fluoxastrobin, trifloxystrobin, N-(5-chloro-2-isopropylbenzyl)-N-cyclopropyl-3-(difluoromethyl)-5-fluoro-1-methyl-iH-pyrazole-4-carboxamide, (3S,6S,7R,8R)-8-benzyl-3-[({3[(isobutyryloxy)methoxy]-4-methoxypyridin-2-yl}carbonyl)amino]-6-methyl-4,9-dioxo-1,5-dioxonan-7yl 2-methylpropanoate (lyserphenvalpyr) and fluopyram.

In addition, all the compositions and/or combinations of the invention may optionally comprise liquid fillers, for example vegetable or mineral oils or esters of vegetable or mineral oils. Suitable vegetable oils are all oils which can typically be used in agrochemicals and can be obtained from plants. Examples include sunflower oil, rapeseed oil, olive oil, castor oil, colza oil, corn oil, cottonseed oil, walnut oil, coconut oil and soya oil. Possible esters are, for example, ethylhexyl palmitate, ethylhexyl oleate, ethylhexyl myristate, ethylhexyl caprylate, isopropyl myristate, isopropyl palmitate, methyl oleate, methyl palmitate, ethyl oleate. Possible mineral oils are Exxsol D100 and white oils.

All the compositions and/or combinations of the invention may comprise further additives such as emulsifiers, penetrants, wetting agents, spreading agents and/or retention agents. Suitable substances are all of those which can typically be used for this purpose in agrochemicals. Suitable additives are, for example, organomodified polysiloxanes, e.g. BreakThru® OE444, BreakThru® S240, Silwett® L77, Silwett® 408; tristyrylphenol ethoxylate, e.g. POE-16 POLYSTEP® TSP-16; ethoxy (5) tridecyl mono/di phosphate, e.g. Crodafos™ T5A; polyalkoxylated butyl ether, e.g. Witconol™ NS 500 LQ; Sorbitan monolaurate ethoxylated (20EO), e.g. Tween® 20.

Additional suitable additives which may be present in all the compositions of the invention are defoamers, preservatives, antioxidants, dyes and inert fillers.

Suitable defoamers are all substances which can typically be used for this purpose in agrochemicals. Preference is given to silicone oils, silicone oil formulations, magnesium stearate, phosphinic acids and phosphonic acids. Examples are Silcolapse® 482 from Bluestar Silicones, Silfoam® SCI 132 from Wacker [dimethylsiloxanes and -silicones, CAS No. 63148-62-9], SAG 1538 or SAG 1572 from Momentive [dimethylsiloxanes and -silicones, CAS-Nr. 63148-62-9] or Fluowet® PL 80.

Possible preservatives are all substances which can typically be used for this purpose in agrochemicals. Suitable preservatives are, for example, formulations comprising 5-chloro-2-methyl-4-isothiazolin-3-one [CIT; CAS No. 26172-55-4], 2-methyl-4-isothiazolin-3-one [MIT, CAS No. 2682-204] or 1,2-benzisothiazol-3(2H)-one [BIT, CAS No. 2634-33-5]. Examples include Preventol® D7 (Lanxess), Kathon® CG/ICP (Rohm & Haas), Acticide® SPX (Thor GmbH) and Proxel® GXL (ArchChemicals).

Suitable antioxidants are all substances which can typically be used for this purpose in agrochemicals. Preference is given to butylhydroxytoluene [3,5-di-tert-butyl-4-hydroxytoluene, CAS No. 128-37-0] and citric acid.

Possible dyes are all substances which can typically be used for this purpose in agrochemicals. Examples include titanium dioxide, carbon black, zinc oxide, blue pigments, red pigments and Permanent Red FGR.

Suitable inert fillers are all substances which can typically be used for this purpose in agrochemicals and which do not function as thickeners. Preference is given to inorganic particles such as carbonates, silicates and oxides, and also organic substances such as urea-formaldehyde condensates. Examples include kaolin, rutile, silicon dioxide (“finely divided silica”), silica gel and natural and synthetic silicates, and additionally talc.

All the compositions and/or combinations of the invention can be applied in undiluted form or diluted with water. In general, they are diluted with at least one part water, preferably with 10 parts water and more preferably with at least 100 parts water, for example with 1 to 10000, preferably 10 to 5000 and more preferably with 50 to 24,000 parts water, based on one part of the formulation.

The present invention likewise provides an emulsion obtainable by mixing water with the liquid compositions of the invention. The mixing ratio of water to emulsion concentrate may be in the range from 1500:1 to 1:1, preferably 500:1 to 10:1.

The dilution is achieved by pouring the emulsion concentrates of the invention into the water. For rapid mixing of the concentrate with water, it is customary to use agitation, for example stirring. However, agitation is generally unnecessary. Even though the temperature for the dilution operation is an uncritical factor, dilutions are typically conducted at temperatures in the range from 00° C. to 50° C., especially at 10° C. to 30° C. or at ambient temperature.

The water used for dilution is generally tap water. The water may, however, already contain water soluble or finely dispersed compounds which are used in crop protection, for instance nutrients, fertilizers or pesticides. It is possible to add various kinds of oils, wetting agents, adjuvants, fertilizers or micronutrients and further pesticides (e.g. herbicides, insecticides, fungicides, growth regulators, safeners) to the emulsion of the invention in the form of a premix or, if appropriate, not until shortly before use (tank-mix). These may be added to the compositions of the invention in a weight ratio of 1:100 to 100:1, preferably 1:10 to 10:1.

The user will apply the compositions of the invention typically from a pre-dosing system, a backpack sprayer, a spraying tank, a spraying aircraft or an irrigation system; the compositions of the invention is typically diluted to the desired deployment concentration with water, buffer and/or further auxiliaries, which affords the ready-to-use spray liquid or agrochemical composition of the invention. Typically, 20 to 2000 liters, preferably 50 to 400 liters, of the ready-to-use spray liquid are deployed per hectare of useful agricultural area.

The generally diluted compositions of the invention are applied mainly by spraying, especially spraying of the leaves. Application can be conducted by spraying techniques known to those skilled in the art, for example using water as carrier and amounts of spray liquid of about 50 to 1000 liters per hectare, for example from 100 to 200 liters per hectare.

The novel triazole-containing compositions have advantageous properties in respect of the treatment of plants; more particularly, they feature good use properties, high stability and high fungicidal activity.

The invention is illustrated by the following examples without limiting it thereby.

### EXAMPLES

### Example 1—Prothioconazole Formulation A

TABLE 1

| Component | % by weight |
|---|---|
| Prothioconazole Tech | 25.5 |
| Synergen SOC (C10/C12 fatty alcohol-3- | 25.5 |
| 8 EO-3-8 PO & C16/C18 fatty alcohol-5- | |
| 10 EO-4-9 PO) | |
| N-octylpyrrolidone (NOP) | 19.9 |
| Genagen 4296 (Dimethyldecanamide) | 20.0 |
| CO 40 (castor oil ethoxylate, POE-40) | 9.1 |

1. Genagen 4296 and NOP were added to reaction vessel.
2. Prothioconazole tech. was added to the reaction vessel while mixing.
3. Synergen SOC and CO 40 were added gradually the to the reaction vessel while mixing until the solution was clear.

### Example 2—Prothioconazole Formulation B

TABLE 2

| Component | % by weight |
|---|---|
| Prothioconazole Tech | 25.5 |
| Synergen SOC (C10/C12 fatty alcohol-3- | 25.5 |
| 8 EO-3-8 PO & C16/C18 fatty alcohol-5- | |
| 10 EO-4-9 PO) | |
| N-octylpyrrolidone (NOP) | 19.9 |
| Genagen 4296 (Dimethyldecanamide) | 20.0 |
| Genapole X-80 (Isotridecyl polyethylene | 9.1 |
| glycol ether with 8 moles ethylene oxide) | |

1. Genagen 4296 and NOP were added to reaction vessel.
2. Prothioconazole tech. was added to the reaction vessel while mixing.
3. Synergen SOC and Genapole X-80 were added gradually the to the reaction vessel while mixing until the solution was clear.

### Example 3—Prothioconazole Formulation C

TABLE 3

| Component | % by weight |
|---|---|
| Prothioconazole Tech | 25.5 |
| Synergen SOC (C10/C12 fatty alcohol-3- | 25.5 |
| 8 EO-3-8 PO & C16/C18 fatty alcohol-5- | |
| 10 EO-4-9 PO) | |
| Genagen 4296 (Dimethyldecanamide) | 39.9 |
| CO 40 (castor oil ethoxylate, POE-40) | 9.1 |

1. Genagen 4296 and NOP were added to reaction vessel.
2. Prothioconazole tech. was added to the reaction vessel while mixing.
3. Synergen SOC and CO 40 were added gradually the to the reaction vessel while mixing until the solution was clear.

### Example 4—Prothioconazole Formulation D

TABLE 4

| Component | % by weight |
|---|---|
| Prothioconazole Tech | 25.5 |
| Synergen SOC (C10/C12 fatty alcohol-3- | 25.5 |
| 8 EO-3-8 PO & C16/C18 fatty alcohol-5- | |
| 10 EO-4-9 PO) | |
| Genagen 4296 (Dimethyldecanamide) | 39.9 |
| Genapole X-80 (Isotridecyl polyethylene | 9.1 |
| glycol ether with 8 moles ethylene oxide) | |

1. Genagen 4296 and NOP were added to reaction vessel.
2. Prothioconazole tech. was added to the reaction vessel while mixing.
3. Synergen SOC and Genapole X-80 were added gradually the to the reaction vessel while mixing until the solution was clear.

### Example 5—Prothioconazole Formulation E

TABLE 5

| Component | % by weight |
|---|---|
| Prothioconazole Tech | 24.6 |
| Genagen 4296 (Dimethyldecanamide) | 22.2 |
| N-octylpyrrolidone (NOP) | 22.2 |
| CO 20 (castor oil ethoxylate, POE-20) | 3.0 |
| Rhodaphac-PA/23 (ethoxylated fatty | 2.0 |
| alcohol, phosphate ester) | |
| Synergen SOC (C10/C12 fatty alcohol-3-8 | 26.0 |
| EO-3-8 PO & C16/C18 fatty alcohol-5-10 | |
| EO-4-9 PO) | |

1. Genagen 4296, NOP and Synergen SOC were charged to reaction vessel and heat up to 35° C.
2. At 35° C. Prothioconazole tech. was added and mixed until full dissolving was obtained.
3. At 35° C. Rhodaphac-PA/23 and CO 20 were added and mixed until the solution was clear.
4. The solution was cooled to 25° C.
5. The solution was filtered through 2.5 μm filter.

### Example 6—Prothioconazole Formulation F

TABLE 6

| Component | % by weight |
|---|---|
| Prothioconazole Tech | 24.5 |
| Steposol Met 10U (N,N-dimethyl 9- | 29.0 |
| decenamide) | |
| N-octylpyrrolidone (NOP) | 14.5 |
| CO 20 (castor oil ethoxylate, POE-20) | 4.2 |
| Rhodaphac-PA/23 (ethoxylated fatty | 2.8 |
| alcohol, phosphate ester) | |
| Synergen SOC (C10/C12 fatty alcohol-3-8 | 25.0 |
| EO-3-8 PO & C16/C18 fatty alcohol-5-10 | |
| EO-4-9 PO) | |

1. Steposol Met 10U, NOP and Synergen SOC were charged to reaction vessel and heat up to 35° C.
2. At 35° C. Prothioconazole tech. was added and mixed until full dissolving was obtained.
3. At 35° C. Rhodaphac-PA/23 and CO 20 were added and mixed until the solution was clear.
4. The solution was cooled to 25° C.
5. The solution was filtered through 2.5 μm filter.

### Example 7—Prothioconazole Formulation G

TABLE 7

| Component | % by weight |
|---|---|
| Prothioconazole Tech | 24.0 |
| Acetophenone | 29.3 |
| N-octylpyrrolidone (NOP) | 14.7 |
| TSP16 (Tristyrylphenol ethoxylate 16) | 12.0 |
| Crodafos T5A (ethoxy (5) tridecyl mono/di | 3.0 |
| phosphate) | |
| Witconol NS 500 LQ (EO, PO | 2.0 |
| polyalkoxylated butyl ether) | |
| Agnique BP (C16/C18 fatty alcohol EO, | 15.0 |
| PO) | |

1. Acetophenone, NOP and Agnique BP were charged to reaction vessel and heat up to 35° C.
2. At 35° C. Prothioconazole tech. was added and mixed until full dissolving was obtained.
3. At 35° C. TSP16, Crodafos T5A and Witconol NS 500 LQ were added and mixed until the solution was clear.
4. The solution was cooled to 25° C.
5. The solution was filtered through 2.5 μm filter.

### Example 8—Prothioconazole Formulation H

TABLE 8

| Component | % by weight |
|---|---|
| Prothioconazole Tech | 24.8 |
| 2-Heptanone | 28.8 |
| N-octylpyrrolidone (NOP) | 14.4 |
| TSP16 (Tristyrylphenol ethoxylate 16) | 5.5 |
| Crodafos T5A (ethoxy (5) tridecyl mono/di | 2.5 |
| phosphate) | |
| Witconol NS 500 LQ (EO, PO | 2.0 |
| polyalkoxylated butyl ether) | |
| Soprophor 3D33 (2,4,6-tris(1- | 2.0 |
| phenylethyl)polyoxyethylenated | |
| phosphates) | |
| Tween 20 (Sorbitan monolaurate | 2.0 |
| ethoxylated 20EO) | |
| Synergen SOC (C10/CT2 fatty alcohol-3-8 | 18.0 |
| EO-3-8 PO & C16/C18 fatty alcohol-5-10 | |
| EO-4-9 PO) | |

1. 2-Heptanone, NOP and Synergen SOC were charged to reaction vessel and heat up to 35° C.
2. At 35° C. Prothioconazole tech. was added and mixed until full dissolving was obtained.
3. At 35° C. TSP16, Crodafos T5A, Soprophor 3D33, Tween 20 and Witconol NS 500 LQ were added and mixed until the solution was clear.
4. The solution was cooled to 25° C.
5. The solution was filtered through 2.5 μm filter.

### Example 9—Prothioconazole Formulation I

TABLE 9

| Component | % by weight |
|---|---|
| Prothioconazole Tech | 23.26 |
| (as 100% a.i) | |
| Soprophor 3D33 (2,4,6-tris(1- | 16.28 |
| phenylethyl)polyoxyethylenated | |
| phosphates) | |
| Synergen SOC (C10/C12 fatty alcohol- | 4.19 |
| 3-8 EO-3-8 PO & C16/C18 fatty | |
| alcohol-5-10 EO-4-9 PO) | |
| Agnique 420 (Alcohols, C16-18, | 9.77 |
| ethoxylated propoxylated) | |
| Agsolex 8 (N-octylpyrrolidone (NOP)) | 13.95 |
| Acetophenone | 32.56 |

1. Acetophenone, NOP, Agnique 420 and Synergen SOC were charged to reaction vessel and heat up to 35° C.
2. At 35° C. Prothioconazole tech. was added and mixed until full dissolving was obtained.
3. At 35° C. Soprophor 3D33 was added and mixed until the solution was clear.
4. The solution was cooled to 25° C.
5. The solution was filtered through 2.5 μm filter.

### Example 10—Prothioconazole Formulation J

TABLE 10

| Component | % by weight |
|---|---|
| Prothioconazole Tech (as 100% a.i) | 23.15% |
| Soprophor ® TS/16 (Tristyrylphenol ethoxylate 16) | 16.20% |
| Synergen SOC (C10/C12 fatty alcohol-3-8 EO-3-8 PO & | 4.17% |
| C16/C18 fatty alcohol-5-10 EO-4-9 PO) | |
| Agnique 420 (Alcohols, C16-18, ethoxylated propoxylated) | 9.72% |
| Agsolex 8 (N-octylpyrrolidone (NOP)) | 13.89% |
| Acetophenone | 32.87% |

1. Acetophenone, NOP, Agnique 420 and Synergen SOC were charged to reaction vessel and heat up to 35° C.
2. At 35° C. Prothioconazole tech. was added and mixed until full dissolving was obtained.
3. At 35° C. Soprophor TS/16 was added and mixed until the solution was clear.
4. The solution was cooled to 25° C.
5. The solution was filtered through 2.5 μm filter.

### Example 11—Efficacy of Prothioconazole Formulations on Zymoseptoria tritici (Protocol 1)

Formulations A and B were prepared in a volume of water corresponding to 200 L/ha.

Winter wheat plants cv. Alixan (Limagrain) at the BBCH 12 growth stage were treated with a hand sprayer at 2 bars calibrated to deliver the equivalent of 200 L/ha. Three replicates (pots) of 6 wheat plants each were used for all conditions tested.

After treatment, wheat plants were left to dry at room temperature and then placed in a climatic chamber: Temperature of 24° C. day/18° C. night—Photoperiod of 16 h light/8 h dark and a Relative Humidity of 65%.

Twenty-four hours after treatments, 5-cm fragments of the first leaf were cut and transferred in Petri dish containing water agar (6 leaf fragments per Petri dish). Leaf fragments were inoculated with a calibrated pycnospore suspension of Zymoseptoria tritici strain Mg Tri-R6 (isolated from French untreated wheat leaf in 2008. Moderately Resistant to DMI fungicides and Highly Resistant to QoI fungicides).

After inoculation, Petri dishes were placed in a climatic chamber: Temperature of 20° C. day/17° C. night—Photoperiod of 16 h light/8 h dark and adapted Relative Humidity Disease assessments are carried out 21 and 28 days post inoculation (dpi) by measuring the length of the necrosis and the total length of the leaf fragment. The intensity of infection is then determined in percent of the total length of the leaf fragment. The values of the intensity of infection obtained are compared by means of the Newman and Keuls test (XL-Stat software, Addinsoft Ltd.).

The Area Under the Disease Progress Curve (AUDPC) is a quantitative measure of disease intensity over time. The most commonly used method for estimating the AUDPC, the trapezoidal method, is performed by multiplying the average disease intensity between each pair of adjacent time points by the time interval corresponding and this for each interval time. The AUDPC is determined with the following formula by adding all of the trapezoids:

$${A}_{k} = {\sum }_{i = 1}^{{N}_{i} - 1} \frac{( {y}_{i} + {y}_{i + 1} )}{2} ( {t}_{i + 1} - {t}_{i} )$$

yi=disease severity at the ith observation
ti=time (days) at the ith observation
N=total number of observations

The fungicide efficacies was determined from the intensity of infection and the AUDPC values and expressed in percent of the untreated control.

TABLE 11

| | | Application | | |
|---|---|---|---|---|
| | | rate g | % Control | |
| # | Treatment | AI/Ha | 21 DAA | 28 DAA |
| 1 | Formulation | 50 | 89.6 | 79.9 |
| | A | | | |
| 2 | Formulation | 50 | 57.4 | 57.3 |
| | B | | | |
| 3 | Formulation | 50 | 73.4 | 61.3 |
| | C | | | |
| 4 | Formulation | 50 | 43.2 | 43.1 |
| | D | | | |

### Conclusions

The results in table 11 clearly show that formulations comprising both carbonyl containing solvent and N-alkyl pyrrolidone (formulations A and B; see tables 1 and 2) are much more potent and effective against the fungi than those that are lacking N-alkyl pyrrolidone (formulations C and D; see tables 3 and 4). (Please see formulation A Vs. C and formulation B Vs. D).

It is also evident from the results in table 11 that the compositions which include compounds of formula (II), in this case castor oil ethoxylate with carbon chain length of C16-C18 (formulations A and C; see tables 1 and 3) are much more potent and effective against the fungi than the compositions which include compounds such as Genapole X-80 with carbon chain length of C13 (formulations B and D; see tables 2 and 4). (Please see formulation A Vs. B and formulation C Vs. D).

### Example 12—Efficacy of Prothioconazole Formulations on Zymoseptoria tritici (Protocol 2)

Winter wheat plants cv. Alixan (Limagrain) at the BBCH 12 growth stage were treated with a hand sprayer at 2 bars calibrated to deliver the equivalent of 200 L/ha. Three replicates (pots) of 6 wheat plants each were used for all conditions tested.

After treatment, wheat plants were left to dry at room temperature for 1 hour and then placed in a climatic chamber: Temperature of 24° C. day/18° C. night—Photoperiod of 16 h light/8 h dark and a Relative Humidity of 65%.

Twenty-four hours after treatments, 5-cm fragments of the first leaf were cut and transferred on 90-mm diameter Petri dish containing water agar supplemented with an anti-senescing compound (6 leaf fragments per Petri dish). Leaf fragments were then inoculated with a paint brush deeped into the calibrated pycnospores suspension of

M. graminicola strain Mg Tri-R6 (isolated from French untreated wheat leaves in 2008.

Moderately Resistant to DMI fungicides and Highly Resistant to QoI fungicides).

After inoculation, Petri dishes were placed in a climatic chamber: Temperature of 20° C. day/17° C. night—Photoperiod of 16 h light/8 h dark and a Relative Humidity of 100% for 5 days and then of 85%.

Disease assessments are carried out 21 days post inoculation (dpi) by measuring the length of the necrosis and the total length of the leaf fragment. The intensity of infection is then determined in percent of the total length of the leaf fragment. The values of the intensity of infection obtained are compared by means of the Newman and Keuls test (XL-Stat software, Addinsoft Ltd.).

The Area Under the Disease Progress Curve (AUDPC) is a quantitative measure of disease intensity over time. The most commonly used method for estimating the AUDPC, the trapezoidal method, is performed by multiplying the average disease intensity between each pair of adjacent time points by the time interval corresponding and this for each interval time. The AUDPC is determined with the following formula by adding all of the trapezoids:

$${A}_{k} = {\sum }_{i = 1}^{{N}_{i} - 1} \frac{( {y}_{i} + {y}_{i + 1} )}{2} ( {t}_{i + 1} - {t}_{i} )$$

yi=disease severity at the ith observation
ti=time (days) at the ith observation
N=total number of observations

The fungicide efficacies were determined from the intensity of infection and the AUDPC values and expressed in percent of the untreated control.

TABLE 12

| | | Application | % Control |
|---|---|---|---|
| # | Treatment | rate g AI/Ha | 21 DAA |
| 1 | Formulation E | 50 | 90.9 |
| 2 | Formulation F | 50 | 95.3 |
| 3 | Formulation G | 50 | 91.8 |
| 4 | Formulation H | 50 | 88.0 |
| 5 | JOAO (Bayer) without NOP | 50 | 85.9 |

### Conclusions

JOAO® is a emulsifiable concentrate formulation sold by Bayer (active ingredient: prothioconazole at a concentration of 250 g/l) which is lacking NOP.

The results in table 12 clearly show that the formulations of the present invention (formulations E-H, see tables 5-8) are much more potent and effective against the fungi than commercial formulations that exist in the market.

### Examples 13-19—Field Trails for Efficacy Evaluation of the Formulations of the Invention

Several field trials were conducted on diverse crops infected with different diseases.

Proline® is an emulsifiable concentrate formulation sold by Bayer (active ingredient: prothioconazole at a concentration of 250 g/l) which is lacking NOP.

$$PESSEV = pest severity$$

$$PPM = parts per million$$

$$Difference = \% eff of formulation I - \% eff of Proline ® .$$

### Example 13—Biological Efficacy on Puccinia recondita in Wheat

The trials were conducted as outdoor field trials in a complete randomized block design with 4 replicates and a plot size of 10 to 30 square meters in naturally occurring disease infections.

One or two applications were done at BBCH from 30 to 69. For that, the formulation was diluted in water (200 gr/ha of prothioconazole in 200-400 L/ha of water) and then applied with a boom sprayer with pressurized air on the plots.

The flag leaf or the leaf below the flag leaf were assessed at 15 to 29 days after last application. In the assessments the pest severity was assessed.

TABLE 13
PUCCRE (Puccinia recondita)

| | Flag leaf | Flag leaf | Flag leaf | Flag leaf | |
|---|---|---|---|---|---|
| | (=leaf 1) | (=leaf 1) | (=leaf 1) | (=leaf 1) | Mean = |
| Wheat | 15 DAB | 24 DAA | 29 DAA | 27 DAB | 4 |
| Untreated (% disease | 34.0 | 58.8 | 31.2 | 53.2 | 44.3 |
| PESSEV) | | | | | |
| Formulation 1 (% eff) | 75.7 | 98.1 | 87.2 | 83.8 | 86.2 |
| Proline ® (% eff) | 46.3 | 93.2 | 82.9 | 71.9 | 73.6 |
| difference | 29.4 | 4.9 | 4.4 | 11.9 | 12.6 |

The results in table 13 clearly show that formulation I brings an added value in terms of efficacy towards Puccinia recondita in wheat compared to Proline®.

### Example 14—Biological Efficacy on Septoria tritici in Wheat

The trials were conducted as outdoor field trials in a complete randomized block design with 4 replicates and a plot size of 10 to 30 square meters in naturally occurring disease infections.

One or two applications were done at BBCH from 30 to 69. For that, the formulation was diluted in water (200 gr/ha of prothioconazole in 200-400 L/ha of water) and then applied with a boom sprayer with pressurized air on the plots.

The flag leaf or the leaf below the flag leaf were assessed at 15 to 41 days after last application. In the assessments the pest severity was assessed.

TABLE 14
SEPTTR (Septoria tritici)

| | Flag leaf | Flag leaf | Leaf 2 | Leaf 2 | |
|---|---|---|---|---|---|
| | (=leaf 1) | (=leaf 1) | 27 | 41 | Mean = |
| Wheat | 15 DAB | 29 DAB | DAB | DAB | 4 |
| Untreated (% | 28.0 | 15.6 | 18.0 | 53.8 | 28.9 |
| disease PESSEV) | | | | | |
| Formulation I | 83.7 | 88.8 | 88.9 | 86.6 | 87.0 |
| (% eff) | | | | | |
| Proline ® (% eff) | 66.4 | 80.4 | 75.6 | 50.6 | 68.2 |
| difference | 17.3 | 8.4 | 13.3 | 36.0 | 18.8 |

The results in table 14 clearly show that formulation I brings an added value in terms of efficacy towards Septoria tritici in wheat compared to Proline®.

### Example 15—Biological Efficacy on Fusarium culmorum in Wheat

The trials were conducted as outdoor field trials in a complete randomized block design with 4 replicates and a plot size of 20 to 22.5 square meters. One trial was done in naturally occurring disease infection another trial was artificially inoculated.

One application was done at BBCH from 61 to 65. For that, the formulation was diluted in water (200 gr/ha of prothioconazole in 200-300 L/ha of water) and then applied with a boom sprayer with pressurized air on the plots.

The ears were assessed at 21 to 35 days after last application. In the assessments the pest severity was assessed. Additionally, the DON content was determined after yield (44-100 days after application).

TABLE 15
FUSACU (Fusarium culmorum)

| | Ear | Ear | |
|---|---|---|---|
| Wheat | 21 DAA | 35 DAA | Mean = 2 |
| Untreated (% disease PESSEV) | 25.8 | 100 | 62.9 |
| Formulation 1 (% eff) | 70.4 | 60.8 | 65.6 |
| Proline ® (% eff) | 63.2 | 54.3 | 58.8 |
| difference | 7.2 | 6.5 | 6.8 |

The results in table 15 clearly show that formulation I brings an added value in terms of efficacy towards Fusarium culmorum in wheat compared to Proline®.

TABLE 16
FUSACU (Fusarium culmorum)

| | Grain/DON | Grain/DON | |
|---|---|---|---|
| Wheat | 44 DAA | 100 DAA | Mean = 2 |
| Untreated (DON ppm) | 8,628 | 53,800 | 31,213 |
| Formulation 1 (% eff) | 50 | 83.1 | 66.6 |
| Proline ® (% eff) | 36 | 74.3 | 55.2 |
| difference | 14 | 8.8 | 11.4 |

The results in table 16 clearly show that formulation I brings an added value in terms of reduction of DON in wheat infected with Fusarium culmorum compared to Proline®.

### Example 16—Biological Efficacy on Puccinia recondita in Triticale

The trials were conducted as outdoor field trials in a complete randomized block design with 4 replicates and a plot size of 19.25 to 21 square meters in naturally occurring disease infections.

One or two applications were done at BBCH from 35 to 61. For that, the formulation was diluted in water (200 gr/ha of prothioconazole in 200 L/ha of water) and then applied with a boom sprayer with pressurized air on the plots.

The flag leaf was assessed at 26 to 28 days after last application. In the assessments the pest severity was assessed.

TABLE 17
PUCCRE (Puccinia recondita)

| | Flag leaf | Flag leaf | |
|---|---|---|---|
| | (=leaf 1) | (=leaf 1) | |
| Triticale | 28 DAB | 26 DAB | Mean = 2 |
| Untreated (% disease | 10.3 | 42.8 | 26.5 |
| PESSEV) | | | |
| Formulation 1 (% eff) | 83.1 | 82.6 | 82.8 |
| Proline ® (% eff) | 60.8 | 71.7 | 66.3 |
| difference | 22.2 | 10.9 | 16.6 |

The results in table 17 clearly show that formulation I brings an added value in terms of efficacy towards Puccinia recondita in triticale compared to Proline®.

### Example 17—Biological Efficacy on Septoria tritici in Triticale

The trials were conducted as outdoor field trials in a complete randomized block design with 4 replicates and a plot size of 19.25 square meters in naturally occurring disease infections.

Two applications were done at BBCH from 37 to 55. For that, the formulation was diluted in water (200 gr/ha of prothioconazole in 200 L/ha of water) and then applied with a boom sprayer with pressurized air on the plots.

The flag leaf was assessed at 27 days after last application. In the assessments the pest severity was assessed.

TABLE 18
SEPTTR (Septoria tritici)

| | Flag leaf (=leaf 1) |
|---|---|
| Triticale | 27 DAB |
| Untreated (% disease PESSEV) | 30.3 |
| Formulation 1 (% eff) | 92.9 |
| Proline ® (% eff) | 90.1 |
| difference | 2.8 |

The results in table 18 clearly show that formulation I brings an added value in terms of efficacy towards Septoria tritici in triticale compared to Proline®.

### Example 18—Biological Efficacy on Pyrenophora teres in Barley

The trial was conducted as outdoor field trials in a complete randomized block design with 4 replicates and a plot size of 30 square meters in naturally occurring disease infections.

One application was done at BBCH from 51. For that, the formulation was diluted in water (200 gr/ha of prothioconazole in 300 L/ha of water) and then applied with a boom sprayer with pressurized air on the plots.

The leaf below the flag leaf was assessed at 15 days after last application. In the assessments the pest severity was assessed.

TABLE 19
PYRNTE (Pyrenophora teres)

| | Leaf 2 |
|---|---|
| Barley | 15 DAB |
| Untreated (% disease PESSEV) | 15.9 |
| Formulation 1 (% eff) | 71.8 |
| Proline ® (% eff) | 60.4 |
| difference | 11.4 |

The results in table 19 clearly show that formulation I brings an added value in terms of efficacy towards Pyrenophora teres in barley compared to Proline®.

### Example 19—Biological Efficacy on Rhynchosporium Secalis in Rye

The trial was conducted as outdoor field trials in a complete randomized block design with 4 replicates and a plot size of 20 square meters in naturally occurring disease infections.

One application was done at BBCH 65. For that, the formulation was diluted in water (200 gr/ha of prothioconazole in 200 L/ha of water) and then applied with a boom sprayer with pressurized air on the plots.

The leaf below the flag leaf was assessed 49 days after last application. In the assessments the pest severity was assessed.

TABLE 20
RHYNSE (Rhynchosporium secalis)

| | Leaf 2 |
|---|---|
| Rye | 49 DAA |
| Untreated (% disease PESSEV) | 24.3 |
| Formulation 1 (% eff) | 69.1 |
| Proline ® (% eff) | 58.8 |
| difference | 10.3 |

The results in table 20 clearly show that formulation I brings an added value in terms of efficacy towards Rhynchosporium secalis in barley compared to Proline®.

### Example 20—Efficacy of Prothioconazole Formulations on Zymoseptoria tritici

The two formulations were tested at rate of 25 g a.i./ha corresponding to 125 mg a.i./L or ppm. The fungicides were prepared one hour before treatment in a volume of water corresponding to 200 l/ha.

The fungicides were pulverized by the aim of a hand sprayer on wheat plants cv. ALIXAN at BBCH 12. Control plants were treated with distilled water. Three replicates (pots) of 6 wheat plants each were used for each condition tested.

After treatment, wheat plants were left to dry at room temperature for 1 hour and then placed in a climatic chamber: Temperature of 24° C. day/18° C. night—Photoperiod of 16 h light/8 h dark and a Relative Humidity of 65%.

Twenty-four hours after treatments, wheat leaf fragments of the first leaf were cut and transferred in Petri dish containing adapted water agar (6 leaf fragments per Petri dish). Leaf fragments were inoculated with a calibrated pycnospores suspension of Z. tritici strain Mg Tri-R6.

After inoculation, Petri dishes were placed in a climatic chamber: Temperature of 20° C. day/17° C. night—Photoperiod of 16 h light/8 h dark and controlled Relative Humidity.

Disease assessments were carried out 28 days post inoculation (dpi) by measuring the length of the necrosis of the leaf fragment. The intensity of infection was then determined in percent of the total length of the leaf fragment.

The Area Under the Disease Progress Curve (AUDPC) is a quantitative measure of disease intensity over time. The most commonly used method for estimating the AUDPC, the trapezoidal method, is performed by multiplying the average disease intensity between each pair of adjacent time points by the time interval corresponding and this for each interval time. The AUDPC was determined with the following formula by adding all of the trapezoids:

$${A}_{k} = {\sum }_{i = 1}^{{N}_{i} - 1} \frac{( {y}_{i} + {y}_{i + 1} )}{2} ( {t}_{i + 1} - {t}_{i} )$$

yi=disease severity at the ith observation
ti=time (days) at the ith observation
N=total number of observations

The fungicide efficacies of formulation J and Proline 275 EC by Bayer were determined from the AUDPC values and expressed in percent of the untreated control.

TABLE 21

| | Application | % Control after |
|---|---|---|
| Treatment | rate g AI/Ha | 28 days |
| Formulation J | 25 | 86.7% |
| Proline 275 EC | 25 | 81.3% |

### Conclusions

Proline® 275 EC is an emulsifiable concentrate formulation sold by Bayer (active ingredient: prothioconazole at a concentration of 275 g/l) which is lacking NOP.

The results in table 21 clearly show that the formulation of the present invention (formulation J, see table 10) is much more potent and effective against the fungi than commercial formulation that exist in the market.

### Example 21—Leaf Migration Test

Leaf migration test: treatment selectively applied only on the central section of the leaf.

Inoculation: 2.5*10\hat{ }6 CFU/ml inoculum suspension, sprayed using the atomizer.

Petri dish maintenance: lab bench, 23-17Co, ambient RH, constant LED light.

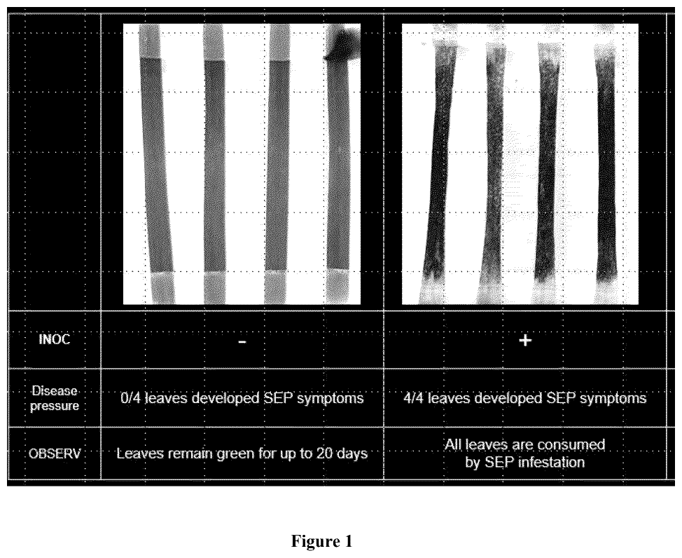

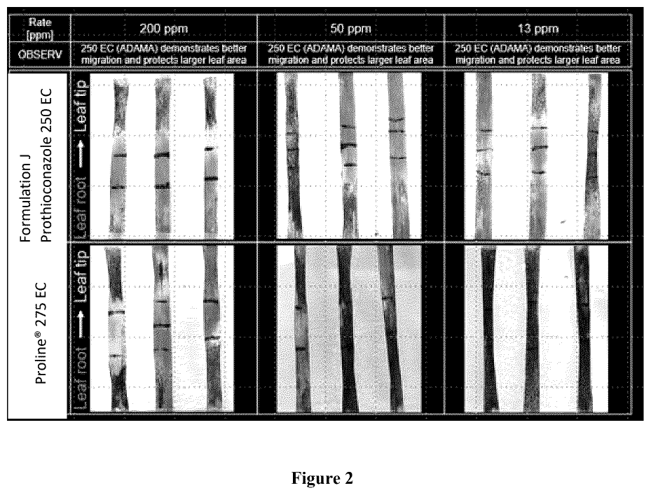

Phenotyping: visual evaluation and imaging at DAS_16. The results are shown in FIGS. 1 and 2.

### Evaluation Methodology:

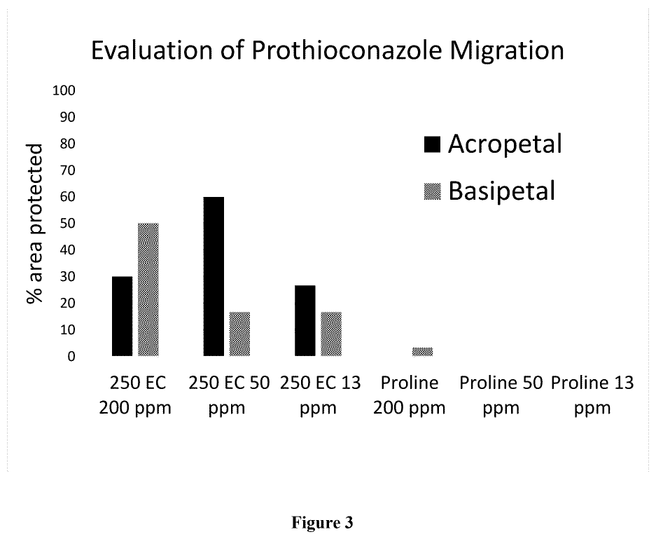

Relative area free of Septoria pycnidia was evaluated on each individual leaf above (acropetal) and below (basipetal) the treated area. The results are shown in Table 22 and FIG. 3.

TABLE 22
Results of the leaf migration test

| | Acropetal protection | | | | Basipetal protection | | | |
|---|---|---|---|---|---|---|---|---|
| | % area protected | | | | % area protected | | | |
| Treatment | Leaf 1 | Leaf 2 | Leaf 3 | Average | Leaf 1 | Leaf 2 | Leaf 3 | Average |
| Formulation J | 30 | 30 | 30 | 30 | 50 | 50 | 50 | 50 |
| (250 EC) 200 ppm | | | | | | | | |
| Formulation J | 0 | 80 | 100 | 60 | 0 | 20 | 30 | 17 |
| (250 EC) 50 ppm | | | | | | | | |
| Formulation J | 70 | 10 | 0 | 27 | 0 | 50 | 0 | 17 |
| (250 EC) 13 ppm | | | | | | | | |
| Proline 200 ppm | 0 | 0 | 0 | 0 | 0 | 10 | 0 | 3 |
| Proline 50 ppm | 0 | 0 | 0 | 0 | 0 | 0 | 0 | 0 |
| Proline 13 ppm | 0 | 0 | 0 | 0 | 0 | 0 | 0 | 0 |

### Conclusions

Formulation J (250 EC) demonstrated a better migration ability, affecting larger area adjacent to the treated segment both acropetally and basipetally.

1. An agrochemical composition comprising:
a) at least one triazole fungicide;
b) a carbonyl containing solvent; and
c) N-alkyl pyrrolidone of formula (I): 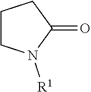
wherein R1 is a straight or branched, saturated or unsaturated, substituted or unsubstituted hydrocarbon group having from 4 to 10 carbon atoms;

2. The composition according to claim 1, wherein the triazole fungicides are selected from azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof.

3. The composition according to claim 2, wherein the triazole fungicide is prothioconazole.

4. The composition according to any one of claims 1-3, wherein the carbonyl containing solvent is selected from the groups of ketones, amides, ureas, esters, lactones, carbonates and any mixtures thereof.

5. The composition according to claim 4, wherein the ketone is selected from acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctanone, 2,4,6-cycloheptatrien-1-one, acetophenone, propiophenone, 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone, valerophenone and any mixtures thereof.

6. The composition according to any one of claim 4 or 5, wherein the ketone is cyclohexanone, acetophenone, heptanone and any mixtures thereof.

7. The composition according to any one of claims 4-6, wherein the ketone is acetophenone.

8. The composition according to claim 4, wherein the amide is selected from N-formylmorpholine, N,N-dimethylformamide, N,N-dimethylacetamide, N,N-imethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, 1,3-dimethyl-2-imidazolidinone, 1,3,4-trimethyl-2-imidazolidinone, 1,3-dimethyl-3,4,5,6-tetrahydro-2(1H)pyrimidinone, 1-heptyl-3-methyl-2-imidazolidinone, 1-heptyl-1,3-dihydro-3-methyl-2H-imidazol2-one and any mixture thereof.

9. The composition according to claim 5, wherein the amide is selected from N,N-dimethyldecanamide, N,N-dimethyldecenamide, N,N-dimethyl-octanamide and any mixture thereof.

10. The composition according to any one of claims 1-9, wherein, in formula (I), R1 is a hydrocarbon group having from 7 to 9 carbon atoms.

11. The composition according to claim 10, wherein, in formula (I), R1 is a hydrocarbon group having 8 carbon atoms.

12. The composition according to any one of claims 1-11, wherein the ratio between the carbonyl containing solvent and the N-alkyl pyrrolidone of formula (I) is of about 0.5:1 to about 3:1.

13. The composition according to claim 12, wherein the ratio between the carbonyl containing solvent and the N-alkyl pyrrolidone of formula (I) is of about 1:1 to about 2:1.

14. The composition according to any one of claims 1-13, wherein the amount of the triazole fungicide in the composition is about 0.1% to about 50% by weight, based on the total weight of the composition.

15. The composition according to claim 14, wherein the amount of the triazole fungicide in the composition is about 10% to about 30% by weight, based on the total weight of the composition.

16. The composition according to claim 15, wherein the amount of the triazole fungicide in the composition is about 20% to about 25% by weight, based on the total weight of the composition.

17. A method for controlling and/or preventing pests comprising applying an effective amount of the composition according to any one of claims 1-16 to a locus where the pest is to be controlled and/or prevented so as to thereby control and/or prevent the pest.

18. The method of claim 17, wherein the pest is a phytopathogenic harmful fungi.

19. A method for controlling and/or preventing phytopathogenic harmful fungi comprising applying an effective amount of the composition according to any one of claims 1-16 to a locus where the phytopathogenic harmful fungi is to be controlled so as to thereby control the phytopathogenic harmful fungi.

20. The method according to any one of claims 17-19, wherein the locus is a crop field.

21. A method of controlling phytopathogenic harmful fungi in a field of crop comprising applying an effective amount of the composition according to any one of claims 1-16 to a field of crop so as to thereby control the phytopathogenic harmful fungi in the field of crop.

22. The method according to any one of claim 20 or 21, wherein the crop is selected from the group consisting of wheat, rye, rice, barley, oats, sorghum/millet, triticale, maize, rapeseed, beans, peanuts and sunflowers.

23. The method according to any one of claims 18-22, wherein the phytopathogenic harmful fungi is selected from Septoria species, Fusarium species, Puccinia species, Erisyphe species, Drechslera species, Ramularia species, Mycosphaerella species and Rhynchosporium species.

24. The method according to claim 23, wherein the phytopathogenic harmful fungi is selected from Puccinia recondita, Septoria tritici, Fusarium culmorum, Pyrenophora teres and Rhynchosporium secalis.

25. The method according to any one of claims 17-24, wherein the composition is applied in an amount from about 0.1 L/ha to about 2 L/ha.

26. The method according to claim 25, wherein the composition is applied in an amount from about 00.4 L/ha to about 1 L/ha.

27. The method according to any one of claims 17-26, wherein the composition is applied in an amount from about 20 g/ha of triazole to about 500 g/ha of triazole.

28. The method according to claim 27, wherein the composition is applied in an amount from about 100 g/ha of triazole to about 250 g/ha of triazole.

29. The method according to claim 28, wherein the triazole is prothioconazole.

30. Use of the composition according to any one of claims 1-16 for controlling and/or preventing pests.

31. Use of the composition according to any one of claims 1-16 for controlling or preventing phytopathogenic harmful fungi.

32. Use of a combination of a of carbonyl containing solvent with N-alkyl pyrrolidone of formula (I): 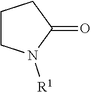
wherein R1 is a straight or branched, saturated or unsaturated, substituted or unsubstituted hydrocarbon group having from 4 to 10 carbon atoms for increasing the efficacy of one or more triazole fungicide.

33. The use according to claim 32, wherein the triazole fungicides are selected from azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof.

34. The use according to claim 33, wherein the triazole fungicide is prothioconazole.

35. The use according to any one of claims 32-34, wherein the carbonyl containing solvent is selected from the groups of ketones, amides, ureas, esters, lactones, carbonates and any mixtures thereof.

36. The use according to claim 35, wherein the ketone is selected from acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctanone, 2,4,6-cycloheptatrien-1-one, acetophenone, propiophenone, 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone, valerophenone and any mixtures thereof.

37. The use according to claim 36, wherein the ketone is cyclohexanone, acetophenone, heptanone and any mixtures thereof.

38. The use according to any one of claims 35-37, wherein the ketone is acetophenone.

39. The use according to claim 35, wherein the amide is selected from N-formylmorpholine, N,N-dimethylformamide, N,N-dimethylacetamide, N,N-imethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, 1,3-dimethyl-2-imidazolidinone, 1,3,4-trimethyl-2-imidazolidinone, 1,3-dimethyl-3,4,5,6-tetrahydro-2(1H)pyrimidinone, 1-heptyl-3-methyl-2-imidazolidinone, 1-heptyl-1,3-dihydro-3-methyl-2H-imidazol2-one and any mixture thereof.

40. The use according to claim 39, wherein the amide is N,N-dimethyldecanamide, N,N-dimethyldecenamide, N,N-dimethyl-octanamide and any mixture thereof.

41. The use according to any one of claims 32-40, wherein, in formula (I), R1 is a hydrocarbon group having from 7 to 9 carbon atoms.

42. The use according to claim 41, wherein, in formula (I), R1 is a hydrocarbon group having 8 carbon atoms.

43. The use according to any one of claims 32-42, wherein the ratio between the carbonyl containing solvent and the N-alkyl pyrrolidone of formula (I) is of about 0.5:1 to about 3:1.

44. The use according to claim 43, wherein the ratio between the carbonyl containing solvent and the N-alkyl pyrrolidone of formula (I) is of about 1:1 to about 2:1.

45. An agrochemical composition comprising:
a) at least one triazole fungicide;
b) a carbonyl containing solvent;
c) N-alkyl pyrrolidone of formula (I): 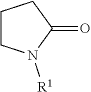
wherein R1 is a straight or branched, saturated or unsaturated, substituted or unsubstituted hydrocarbon group having from 5 to 10 carbon atoms; and
d) an effective amount of compound of formula (II): 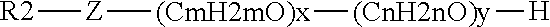
wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atom, m is an integer equal to 2, n is an integer equal to 3, x is an integer of from 3 to 50 and y is an integer of from 0 to 50.

46. The composition according to claim 45, wherein the triazole fungicides are selected from azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof.

47. The composition according to claim 46, wherein the triazole fungicide is prothioconazole.

48. The composition according to any one of claims 45-47, wherein the carbonyl containing solvent is selected from the groups of ketones, amides, ureas, esters, lactones, carbonates and any mixtures thereof.

49. The composition according to claim 48, wherein the ketone is selected from acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctanone, 2,4,6-cycloheptatrien-1-one, acetophenone, propiophenone, 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone, valerophenone and any mixtures thereof.

50. The composition according to claim 49, wherein the ketone is cyclohexanone, acetophenone, heptanone and any mixtures thereof.

51. The composition according to any one of claims 48-50, wherein the ketone is acetophenone.

52. The composition according to claim 48, wherein the amide is selected from N-formylmorpholine, N,N-dimethylformamide, N,N-dimethylacetamide, N,N-imethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, 1,3-dimethyl-2-imidazolidinone, 1,3,4-trimethyl-2-imidazolidinone, 1,3-dimethyl-3,4,5,6-tetrahydro-2(1H)pyrimidinone, 1-heptyl-3-methyl-2-imidazolidinone, 1-heptyl-1,3-dihydro-3-methyl-2H-imidazol2-one and any mixture thereof.

53. The composition according to claim 52, wherein the amide is N,N-dimethyldecanamide, N,N-dimethyldecenamide, N,N-dimethyl-octanamide and any mixture thereof.

54. The composition according to any one of claims 45-53, wherein, in formula (I), R1 is a hydrocarbon group having from 7 to 9 carbon atoms.

55. The composition according to claim 54, wherein, in formula (I), R1 is a hydrocarbon group having 8 carbon atoms.

56. The composition according to any one of claims 45-55, wherein, in formula (II), R2 is linear or branched, saturated or unsaturated alkyl radical having from 16 to 18 carbon atoms, or any combination thereof, Z is selected from oxygen or nitrogen atom, m is an integer equal to 2, n is an integer equal to 3, x is an integer of from 3 to 50 and y is an integer of from 0 to 50.

57. The composition according to any one of claims 45-55, wherein, in formula (II), R2 is linear or branched, saturated or unsaturated acyl radical having from 16 to 18 carbon atoms, or any combination thereof, Z is selected from oxygen or nitrogen atom, m is an integer equal to 2, n is an integer equal to 3, x is an integer of from 3 to 50 and y is an integer of from 0 to 50.

58. The composition according to any one of claim 56 or 57, wherein the compound of formula (II) is equal to or above about 9% based on the total weight of the composition.

59. The composition according to any one of claims 56-58, wherein the compound of formula (II) is equal to or above about 12% based on the total weight of the composition.

60. The composition according to any one of claims 45-59, wherein the ratio between the carbonyl containing solvent and the N-alkyl pyrrolidone of formula (I) is of about 0.5:1 to about 3:1.

61. The composition according to claim 60, wherein the ratio between the carbonyl containing solvent and the N-alkyl pyrrolidone of formula (I) is of about 1:1 to about 2:1.

62. The composition according to any one of claims 45-61, wherein the amount of the triazole fungicide in the composition is about 0.1% to about 50% by weight, based on the total weight of the composition.

63. The composition according to claim 62, wherein the amount of the triazole fungicide in the composition is about 10% to about 30% by weight, based on the total weight of the composition.

64. The composition according to claim 63, wherein the amount of the triazole fungicide in the composition is about 20% to about 25% by weight, based on the total weight of the composition.

65. A method for controlling and/or preventing pests comprising applying an effective amount of the composition according to any one of claims 45-64 to a locus where the pest is to be controlled and/or prevented so as to thereby control and/or prevent the pest.

66. The method of claim 65, wherein the pest is a phytopathogenic harmful fungi.

67. A method for controlling and/or preventing phytopathogenic harmful fungi comprising applying an effective amount of the composition according to any one of claims 45-64 to a locus where the phytopathogenic harmful fungi is to be controlled so as to thereby control the phytopathogenic harmful fungi.

68. The method according to any one of claims 65-67, wherein the locus is a crop field.

69. A method of controlling phytopathogenic harmful fungi in a field of crop comprising applying an effective amount of the composition according to any one of claims 45-64 to a field of crop so as to thereby control the phytopathogenic harmful fungi in the field of crop.

70. The method according to any one of claim 68 or 69, wherein the crop is selected from the group consisting of wheat, rye, rice, barley, oats, sorghum/millet, triticale, maize, rapeseed, beans, peanuts and sunflowers.

71. The method according to any one of claims 68-70, wherein the phytopathogenic harmful fungi is selected from Septoria species, Fusarium species, Puccinia species, Erisyphe species, Drechslera species, Ramularia species, Mycosphaerella species and Rhynchosporium species.

72. The method according to claim 71, wherein the phytopathogenic harmful fungi is selected from Puccinia recondita, Septoria tritici, Fusarium culmorum, Pyrenophora teres and Rhynchosporium secalis.

73. The method according to any one of claims 65-72, wherein the composition is applied in an amount from 0.1 L/ha to about 2 L/ha.

74. The method according to claim 73, wherein the composition is applied in an amount from about 0.4 L/ha to about 1 L/ha.

75. The method according to any one of claims 65-74, wherein the composition is applied in an amount from about 20 g/ha of triazole to about 500 g/ha of triazole.

76. The method according to claim 75, wherein the composition is applied in an amount from about 100 g/ha of triazole to about 250 g/ha of triazole.

77. The method according to any one of claim 75 or 76, wherein the triazole is prothioconazole.

78. Use of the composition according to any one of claims 45-64 for controlling and/or preventing pests.

79. Use of the composition according to any one of claims 45-64 for controlling phytopathogenic harmful fungi.

80. The compositions according to any one of claims 45-64 for use in controlling and/or preventing pests.

81. The compositions according to any one of claims 45-64 for use in controlling phytopathogenic harmful fungi.

82. Use of a compound of formula (II):
R2-Z—(CmH2mO)x-(CnH2nO)y-H
wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atoms, m is an integer equal to 2, n is an integer equal to 3, x is an integer of from 3 to 50 and y is an integer of from 0 to 50 for increasing the efficacy of one or more triazole fungicide.

83. The use according to claim 82, wherein, in formula (II), R2 is linear or branched, saturated or unsaturated alkyl radical having from 16 to 18 carbon atoms, or any combination thereof, Z is selected from oxygen or nitrogen atoms, m is an integer equal to 2, n is an integer equal to 3, x is an integer of from 3 to 50 and y is an integer of from 0 to 50.

84. The use according to claim 82, wherein, in formula (II), R2 is linear or branched, saturated or unsaturated acyl radical having from 16 to 18 carbon atoms, or any combination thereof, Z is selected from oxygen or nitrogen atoms, m is an integer equal to 2, n is an integer equal to 3, x is an integer of from 3 to 50 and y is an integer of from 0 to 50.

85. The use according to any one of claims 82-84, wherein the compound of formula (II) is equal to or above about 9% based on the total weight of the composition.

86. The use according to claim 85, wherein the compound of formula (II) is equal to or above about 12% based on the total weight of the composition.

87. The use according to any one of claims 82-86, wherein the triazole fungicide is selected from azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof.

88. The use according to claim 87, wherein the triazole is prothioconazole.

89. Method of treating plants or plants parts with a combination of one or more triazole fungicide with compound of formula (II): 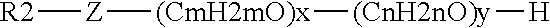
wherein R2 is linear or branched, saturated or unsaturated alkyl radical having from 14 to 20 carbon atoms; or R2 is linear or branched, saturated or unsaturated acyl radical having from 14 to 20 carbon atoms; or any combination thereof, Z is selected from oxygen or nitrogen atoms, m is an integer equal to 2, n is an integer equal to 3, x is an integer of from 3 to 50 and y is an integer of from 0 to 50, wherein the compound of formula (II) is for increasing the efficacy of the one or more triazole(s).

90. The method according to claim 89, wherein the one or more triazole fungicide is selected from azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof.

91. The method according to claim 90, wherein the triazole is prothioconazole.

92. The method according to any one of claims 89-91, wherein, in formula (II), R2 is linear or branched, saturated or unsaturated alkyl radical having from 16 to 18 carbon atoms, or any combination thereof, Z is selected from oxygen or nitrogen atoms, m is an integer equal to 2, n is an integer equal to 3, x is an integer of from 3 to 50 and y is an integer of from 0 to 50.

93. The method according to any one of claims 89-92, wherein, in formula (II), R2 is linear or branched, saturated or unsaturated acyl radical having from 16 to 18 carbon atoms, or any combination thereof, Z is selected from oxygen or nitrogen atoms, m is an integer equal to 2, n is an integer equal to 3, x is an integer of from 3 to 50 and y is an integer of from 0 to 50.

94. The method according to any one of claims 89-93, wherein the compound of formula (II) is equal to or above about 9% based on the total weight of the composition.

95. The method according to claim 94, wherein the compound of formula (II) is equal to or above about 12% based on the total weight of the composition.

96. Method for reducing deoxynivalenol (DON) mycotoxin in a field of crop comprising applying an effective amount of the composition according to any one of claims 1-16 or 45-64 to a crop infected by fungi of the Fusarium species.

97. The method according to claim 96, wherein the crop is selected from the group consisting of wheat, rye, rice, barley, oats, sorghum/millet, triticale, maize, rapeseed, beans, peanuts and sunflowers.

98. The method according to claim 97, wherein the crop is wheat.

99. The method according to claim 96, wherein the Fusarium specie is Fusarium culmorum.

100. Use of the composition according to any one of claims 1-16 or 45-64 for reducing deoxynivalenol (DON) mycotoxin in crop infected by fungi of the Fusarium species.

101. The Use according to claim 100, wherein the Fusarium specie is Fusarium culmorum.
